(19) United States
(12) Patent Application Publication
(10) Pub. No.: US 2018/0077542 A1
(43) Pub. Date: Mar. 15, 2018

(54) UNIFIED ENTERPRISE MOBILE DATA COLLABORATION

(71) Applicant: Kennesaw State University Research and Service Foundation, Inc., Kennesaw, GA (US)

(72) Inventors: Ying XIE, Marietta, GA (US); Varun PATEL, Kennesaw, GA (US)

(73) Assignee: Kennesaw State University Research and Service Foundation, Inc., Kennesaw, GA (US)

(21) Appl. No.: 15/558,732

(22) PCT Filed: Mar. 16, 2016
(86) PCT No.: PCT/US16/22601

§ 371 Date: Sep. 15, 2017

Related U.S. Application Data
(60) Provisional application No. 62/133,580, filed on Mar. 16, 2015.

(51) Int. Cl. H04W 4/12; G06Q 10/10; G06F 17/30; H04L 29/08; H04W 4/08

(52) U.S. Cl. CPC H04W 4/12; G06Q 10/1095; H04W 4/08; H04L 67/26; G06F 17/30864

(57) ABSTRACT

A unified enterprise mobile data system that allows fine distinction and control of groups from individual contacts. The group structures that a user sees in the group screen generally matches the business structures the user works with. When the user is associated with and accesses a screen for a group, s/he sees messages just for this group. Each group is associated with a secured shared data storage space; group calendar, to-do list, and task tracker. The group structure provides a unified entry to access all group associated resources. Aggregate secured shared data storage space, group calendar, to-do list, and task tracker covering all groups with which the user is associated are also accessible to the user, providing rapid generalized access to all the user's information and data. The unified enterprise mobile data system provides dynamic membership for users in geolocation-based groups in response to the user's movements in and around locations of the enterprise.

### CROSS-REFERENCE TO RELATED APPLICATIONS

This application claims priority to U.S. Provisional Patent Application No. 62/133,580 filed Mar. 16, 2015, the entirety of which is incorporated by reference herein.

### BACKGROUND

Inter- and intra-business communications currently rely primarily on email systems, file server systems or shared data stores, and disparate siloed calendaring systems to accomplish messaging, information storage, task and meeting tracking, and telephony (defined as technology associated with the electronic transmission of voice, facsimile, or other information between distant parties using processes analogous to those historically associated with the telephone). Such systems are generally limited to “one-to-one” or “one-to-many” communications, and are not good at either forming hierarchical structures for group communication or for handling complex business communications such as group conference calls, group file sharing, group to-do lists or task tracking, and group scheduling.

Business, however, organizes around groups. Different groups may form hierarchical structures not well served by simple “one-to-one” or “one-to-many” communication and collaboration. In a university system, for example, a hierarchical group structure may be: Office of the Provost, College, Department, Committee, and Working Groups. Groups can be viewed as basic units when carrying out business communications. Typical business communication behaviors include exchanging ideas, conferencing, file sharing, calendaring resources and personnel, and managing to-do lists or tracking task progress.

Current systems are inadequate to flexibly handle communications to such groups for such topics. An email-based implementation of group communications typically requires system administrators to establish hierarchical or topic-specific groups and populate them with lists of individual recipients at each hierarchical level or for each topic. After the initial setup effort, email messages sent by members of the group are delivered to each user's common inbox, where that user must either configure a rule to differentiate the messages for a particular group, or use whatever search function is offered by the email system to locate and access messages by recipient and/or topic.

Email implementations are also generally unsecurable, since users in a working group working on sensitive and/or confidential information are typically free to share that information outside of their group. Email controls, when used, typically do not integrate with other communications services, such as text messaging, instant messaging, and telephony, such that duplicative initial set up efforts are frequently performed on a service-by-service basis in order to add additional communications capabilities and controls.

Other common communications services have their own unique flaws. For example, if public social networks such as Facebook or Twitter are used for business communications, an enterprise usually has no control over user account information and little ability to track communication messages. Public social networks also do not draw clear boundaries between employees' business and personal contacts.

A group-centric, secure, unified communication solution is thus needed.

### SUMMARY

A method for group communication in an enterprise is disclosed. The method comprises the step of accepting, as associated with a first user who is a member of a division of the enterprise, registration information for a first mobile computing device connected to an external electronic communications network. The method comprises the step of storing, in a database by a server computing device connected to an internal electronic communications network behind a firewall, the registration information in a first record associated with the first user. The method comprises the step of accepting a command from a first client program executing on the first mobile computing device to create, of the first user and a second user who is a member of the division of the enterprise, a subgroup within a group corresponding to the division of the enterprise. The method comprises the step of modifying the record associated with the first user to indicate the first user's membership in the subgroup. The method comprises the step of pushing, to a second mobile computing device of the second user, an invitation to join the subgroup. The method comprises the step of accepting, from a second client program on the second mobile computing device, a confirmation that indicates that the second user consents to join the subgroup. The method comprises the step of modifying a second record in the database to indicate the second user's membership in the subgroup. The method comprises the step of pushing a message to the first and second mobile computing devices based on the membership of the first and second user's membership in the first group.

The method may also comprise the step of, upon modifying the record associated with the first user to indicate the first user's membership in the subgroup, granting, to the first user, access to one or more resources associated with the subgroup and selected from the group consisting of a group shared file storage space, a group calendar, a group to-do list, a group task assignment, a group task progress tracker, and a group synchronized voice meeting system. The method may also comprise the step of, upon modifying the record associated with the second user to indicate the second user's membership in the subgroup, granting, to the second user, access to the one or more resources associated with the subgroup to which the first user also has access.

The method may also comprise the step of creating, in the database, an aggregated calendar record associated with the first user that incorporates all calendar events associated with the subgroup and all calendar events associated with a second subgroup within the group in which the first user is also a member, but in which the second user is not a member. The method may also comprise the step of sending that aggregated calendar record to the first mobile computing device.

The method may also comprise the step of sending, to the first mobile computing device, both a calendar event associated with the subgroup and a calendar event associated with a second subgroup within the group in which the first user is also a member, but in which the second user is not a member.

The method may also comprise the step of creating, in the database, an aggregated to-do record associated with the first user that incorporates all to-do items associated with the subgroup and all to-do items associated with a second subgroup within the group in which the first user is also a member, but in which the second user is not a member. The method may also comprise the step of sending that aggregated to-do record to the first mobile computing device.

A method for group communication in an enterprise is disclosed. The method comprises the step of recording, in a database by a server computing device connected to an internal electronic communications network behind a firewall, a record for each of a plurality of users in the enterprise. The method comprises the step of creating, in the database, a group associated with a physical location. The method comprises the step of recording, in the database, registration information for a mobile computing device connected to an external electronic communications network outside the firewall that associates the mobile computing device with a first user among the plurality of users. The method comprises the step of accepting a first message from a client program operated by the mobile computing device that indicates that the mobile computing device has entered into the physical location. The method comprises the step of modifying, in response to receiving the first message, the record for the first user to indicate the first user's membership in the group associated with the physical location. The method comprises the step of sending a message associated with the physical location to all members of the group associated with the physical location. The method comprises the step of accepting a second message from the client program operated by the mobile computing device that indicates that the mobile computing device has exited the physical location. The method comprises the step of modifying, in response to receiving the second message, the record for the first user to indicate the first user's removal from the group associated with the physical location.

The method may also comprise the step of, upon modifying the record associated with the first user to indicate the first user's membership in the group associated with the physical location, granting, to the first user, access to one or more resources associated with the subgroup and selected from the group consisting of a group shared file storage space, a group calendar, a group to-do list, a group task assignment, a group task progress tracker, and a group synchronized voice meeting system. The method may also comprise the step of, upon modifying the record associated with the first user to indicate the first user's removal from the group associated with the physical location, terminating the access of the first user to the one or more resources associated with the group associated with the physical location. In this method the registration information may be a mobile telephone number.

A computer-implemented method for group interaction between members of an enterprise based on membership within divisions of the enterprise. The method comprising the following steps. Storing in a database a set of division membership information that identifies at least a first member and a second member as members of at least a first enterprise division, wherein the storing in the database is performed by a server computing device connected to an internal electronic communications network, wherein the server computing device and the internal electronic communications network are located within the bounds of a firewall, wherein a first member computing device is at least temporarily associated with the first member and a second member computing device is at least temporarily associated with the second member, wherein both the first member computing device and the second member computing device are each located within the bounds of the firewall. Providing access for the first member and the second member to a set of first enterprise division specific content, wherein the set of first enterprise division specific content is stored within the bounds of the firewall. Permitting collaboration of the set of first enterprise division specific content between the first member and the second member. Receiving a set of registration information associated with a third computing device and a third member, wherein the set of division membership information also identifies the third member as a member of at least the first enterprise division, wherein the third computing device is capable of accessing the internal electronic communications network through a connection to an external electronic communications network. Storing the set of registration information in the database. Providing access for the third member to the set of first enterprise division specific content. Permitting collaboration of the set of first enterprise division specific content between the first member, the second member, and the third member. Receiving a command from a first client program executing on the first computing device to create a subdivision within the first enterprise division, wherein the command identifies at least the first member and the third member as members of at least a first enterprise subdivision. Modifying the set of division membership information to include the first enterprise subdivision and to identify the first member and the third member as potential members of the first enterprise subdivision. Pushing an invitation to join the first enterprise subdivision to the third computing device. Accepting a confirmation that indicates that the third member consents to join the subgroup, wherein the confirmation is received from a client program executing on the third computing device. Pushing a message to the first computing device and the third computing device based on the membership of the first member and the third member in the first enterprise subdivision. Providing access for the first member and the third member to a set of first enterprise subdivision specific content, wherein the set of first enterprise subdivision specific content is stored within the bounds of the firewall. And, permitting collaboration of the set of first enterprise subdivision specific content between the first member and the third member.

A computer system for facilitating group interaction between members of an enterprise based on membership within divisions of the enterprise is disclosed. The computer system comprises an internal electronic communications network. The computer system also comprises a server computing device connected to the internal electronic communications network. The server computing device and the internal electronic communications network are located within the bounds of a firewall. The computer system also comprises a database communicatively coupled to the server computing device. Storing in the database is performed by the server computing device. A first member computing device is at least temporarily associated with a first member. A second member computing device is at least temporarily associated with a second member. Both the first member computing device and the second member computing device are each located within the bounds of the firewall. A third member computing device is at least temporarily associated with a third member. The third computing device is capable of accessing the internal electronic communications network through a connection to an external electronic communications network. A set of division membership information identifies at least the first member, the second member, and the third member as members of at least a first enterprise division. The system is configured to provide access for the first member and the second member to a set of first enterprise division specific content. The set of first enterprise division specific content is stored within the bounds of the firewall. The system is further configured to permit collaboration of the set of first enterprise division specific content between the first member and the second member. The system is further configured to receive a set of registration information associated with the third computing device and the third member. The system is further configured to store the set of registration information in the database. The system is further configured to provide access for the third member to the set of first enterprise division specific content. The system is further configured to permit collaboration of the set of first enterprise division specific content between the first member, the second member, and the third member. The system is further configured to receive a command from a first client program executing on the first computing device to create a subdivision within the first enterprise division. The command identifies at least the first member and the third member as members of at least a first enterprise subdivision. The system is further configured to modify the set of division membership information to include the first enterprise subdivision and to identify the first member and the third member as potential members of the first enterprise subdivision. The system is further configured to push an invitation to join the first enterprise subdivision to the third computing device. The system is further configured to accept a confirmation that indicates that the third member consents to join the subgroup. The confirmation is received from a client program executing on the third computing device. The system is further configured to push a message to the first computing device and the third computing device based on the membership of the first member and the third member in the first enterprise subdivision. The system is further configured to provide access for the first member and the third member to a set of first enterprise subdivision specific content. The set of first enterprise subdivision specific content is stored within the bounds of the firewall. The system is further configured to permit collaboration of the set of first enterprise subdivision specific content between the first member and the third member.

### BRIEF DESCRIPTION OF THE DRAWINGS

FIG. 1 is a Venn diagram showing an example hierarchy of user groupings possible under embodiments of the invention.

FIG. 2 is a block diagram of an exemplary computer system.

FIG. 3 diagrams the architecture of an exemplary system and communications network.

FIG. 4 shows a Graphical User Interface (GUI) displaying a user's group list on an example mobile computing device. Shown in a home screen that displays all the groups in which the user participates.

FIG. 5 shows a GUI displaying an exemplary editing mode for a user's group list on an example mobile computing device. In this screen, the user can delete any group from “My Groups” category.

FIG. 6 shows a GUI displaying a summary of new activities in the user's account on an example mobile computing device. Displayed new activities may include being added to a new group by a friend, new messages from groups that the user belongs to, new messages from a business contact of the user, new calendar events, and new task assignments

FIG. 7 shows a GUI displaying exemplary search results of available groups relating to search keyword “tennis” on an example mobile computing device. In the search result list, the user can choose a group to subscribe by clicking the plus icon besides the group name.

FIG. 8 shows a GUI displaying the basic input parameters for creating a group on an example mobile computing device.

FIGS. 9A-M show GUIs displaying exemplary group functions.

FIG. 9A shows a GUI displaying the home screen of a group.

FIG. 9B shows a GUI displaying basic information of a group, including, group name, group admins, and group participants.

FIG. 9C shows a GUI displaying an exemplary QR code associated with a group. One can join a group by scanning the group QR using one's mobile phone.

FIG. 9D shows a GUI displaying list of scheduled group meetings. The user clicks the Join button to join a synchronized group meeting. This screen also shows upcoming meetings of this group.

FIG. 9E shows a GUI displaying the screen of adding a new group meeting. In the participant list, the user can choose participants from the active group or subgroup by clicking the plus icon besides the participants heading.

FIG. 9F shows a GUI displayed to the user participant in a current synchronized group meeting.

FIG. 9G shows a GUI displaying group calendar. Scheduled events of this group are marked on the calendar.

FIG. 9H shows a GUI displaying a screen for adding a new group event to a calendar.

FIG. 9I shows a GUI displaying a group shared space. Each group member can post shared documents, images, and videos to the group shared space for all group members to view.

FIG. 9J shows a GUI displaying group tasks. Each task in the list shows the following information: description, current progress, start date and end date.

FIG. 9K shows a GUI displaying detailed information for a task, which may include group members' comments on the task.

FIG. 9L shows a GUI displaying a screen for adding a new group task.

FIG. 9M shows a GUI displaying current group's subgroups that are accessible to the user. If it is set so, the user may also create a subgroup at this screen.

FIGS. 10A-D show GUs displaying exemplary individual communication features.

FIG. 10A shows a GUI displaying a list of the user's contacts who have sent messages that the user has not read yet. The user can select a contact from the list to view new messages and to reply.

FIG. 10B shows a GUI displaying an interface for messaging between the user and a selected contact, including text messaging and voice messaging.

FIG. 10C shows a GUI displaying all user contacts; selecting a contact in the list leads to this contact's profile page as shown in FIG. 11D.

FIG. 10D shows a GUI displaying the profile of a selected contact by the user; from this screen, the user can choose to chat with the contact.

FIGS. 11A-G show GUIs displaying exemplary aggregated views of all meetings, shared spaces, tasks, and calendars from the groups that the user is part of.

FIG. 11A shows a GUI displaying an exemplary summary screen invoke by selecting a “Me” button; from this screen, a user may have aggregated views of all meetings, shared spaces, tasks, and calendar from user groups, and may also alter app settings.

FIG. 11B shows a GUI displaying a list of a user's current or upcoming group meetings that are aggregated from all groups that the user is part of. The user can join an ongoing meeting by click the join button on this screen.

FIG. 11C shows a GUI displaying an aggregated view of all shared spaces the user can access. These shared spaces are aggregated from all the groups that the user is part of.

FIG. 11D shows a GUI displaying an aggregated view of all user tasks, aggregated from all the groups that the user is part of.

FIG. 11E shows a GUI displaying a user's aggregated calendar; calendared events may come from different user groups and/or from the user's personal events.

FIG. 11F shows a GUI displaying an exemplary screen where a user may add a personal event to the calendar.

FIG. 11G shows a GUI displaying an exemplary screen where a user may alter the settings of the app.

FIG. 12 shows a diagram illustrating an example process of initializing an example user table.

FIG. 13 shows a diagram illustrating an example process of initializing group membership information in an example user table.

FIG. 14 shows a sequence diagram of the interaction of exemplary class functions, when the user acts to update information of an academic “Class” group in an example system.

FIG. 15 shows a state machine diagram for the user's exemplary possible actions when the user may act to update information of an academic “Class” group in an example system.

FIG. 16 shows a class diagram showing the organization of an academic “class” group in an example system.

FIG. 17 shows a simple exemplary database schema.

FIG. 18 shows a process block diagram for a method for group communication in an enterprise.

FIG. 18A shows a segment of a process block diagram for a method for group communication in an enterprise.

FIG. 19 shows a process block diagram for a method for group communication in an enterprise.

FIG. 19A shows a segment of a process block diagram for a method for group communication in an enterprise.

FIG. 20 shows an exemplary database schema.

FIG. 21 shows an exemplary campus map with various geofencing features.

### DETAILED DESCRIPTION

The inventive systems and methods effect improvement in enterprise-wide business communications by providing a unified platform for secure, mobile, multi-type, and multi-level group based business communication. Where exemplary embodiments reference a university use, it will be appreciated that the invention is not limited to an academic environment and also encompasses communications in public, private, startup business environments, etc.

Communication security in the enterprise mobile data system is effected by placing the entire communications system back end behind an enterprise firewall and by limiting access to that communication system to registered users. All business contacts, business communications, and associated data are stored in an enterprise mobile data system server behind the enterprise firewall. The enterprise mobile data system identifies and separates contacts within a business from contacts outside of that business. Only registered mobile devices or internal client computers with enterprise IP addresses can communicate with the enterprise mobile data system server to perform any function that the enterprise mobile data system provides.

Complete mobile access to communications and stored data is central to the enterprise mobile data system; i.e., the entire user function set is accessible from a registered mobile device. In embodiments, access to this complete function set is effected through a mobile data client messaging system program.

The enterprise mobile data system unifies popular types of business communication under a single secure regime. The business communication is governed by groups and subgroups. Within any group or subgroup, members of that group may, if authorized by the administrative settings of the group, use features such as text messaging or voice chat; sharing documents, images, videos, and other data via a shared data store; sharing a group calendar; sharing a group task or to-do list; tracking progress of group tasks; voice conferencing; and creating subgroups.

Group communication management features are highly refined. Each group management function can be performed remotely from the business by a registered mobile computing device. The enterprise mobile data system supports multiple types of groups, including but not limited to official enterprise groups set up for users by the enterprise as well as user-created, ad-hoc groups. The groups can be used for, e.g., announcements, committee discussions, and project collaboration, with the scope of available group functions defined by the group administrator.

In general, groups may be configured as information feed groups, public groups, and private groups. Information feed groups are configured to allow only a designated administrator or administrators to add and remove content. Information feed groups may be initially created by a system administrator who designates one or more group administrators, or by a user who is automatically established as the group administrator. Such group administrators may then have the ability to appoint other group administrators. Information feed groups may be used for announcements, assignments, scheduling, etc. where participatory discussion is not desired. Public groups are configured to allow any authenticated member of the enterprise to join. Public groups may be created by any authenticated member of the enterprise, and that member may have the ability to appoint other group administrators. Public groups may be used for official announcements, assignments, and scheduling, or for groups concerning topics of general interest, where participatory discussion is desired. Private groups are configured as password-protected and/or invitation-only groups (using textual, URL-encoded, or QR-code encoded information) to allow only select members of the enterprise to join. Private groups may also be created by any authenticated member of the enterprise, and that member may have the ability to appoint other group administrators. Private groups may be used like public groups, but with greater control over member participation and activity to limit unwanted or malicious communications. Private groups may also be used for groups concerning special interest topics. The enterprise mobile data system may also support system-generated groups. System-generated groups are configured to automatically enroll group administrators and members, and may serve as required groups where administrators and members are not allowed to manually withdraw from the group. System-generated groups may be established by performing an ETL (exchange, transform, and load) process with other enterprise systems, e.g., a university's course enrollment system and employee/student information system, where criteria such as assignment to teach a particular course (for professors and teaching assistants) and enrollment in a particular course (for students) within these other enterprise systems are used to automatically form the system-generated group, designate group administrators, and add user members within the enterprise mobile data system.

The enterprise mobile data system supports multiple levels of groups, allowing subgroups within groups or further subgroups, as well as overlapping groups allowing users to belong to a number of groups within the enterprise mobile data system. Each group or subgroup is not limited to communications only, but is also associated with shared data store for document sharing and distribution, a group calendar, and a group task scheduler. Thus group-based security on the basis of group membership and feature controls allow for granular set-up and access to and management of each of these functions.

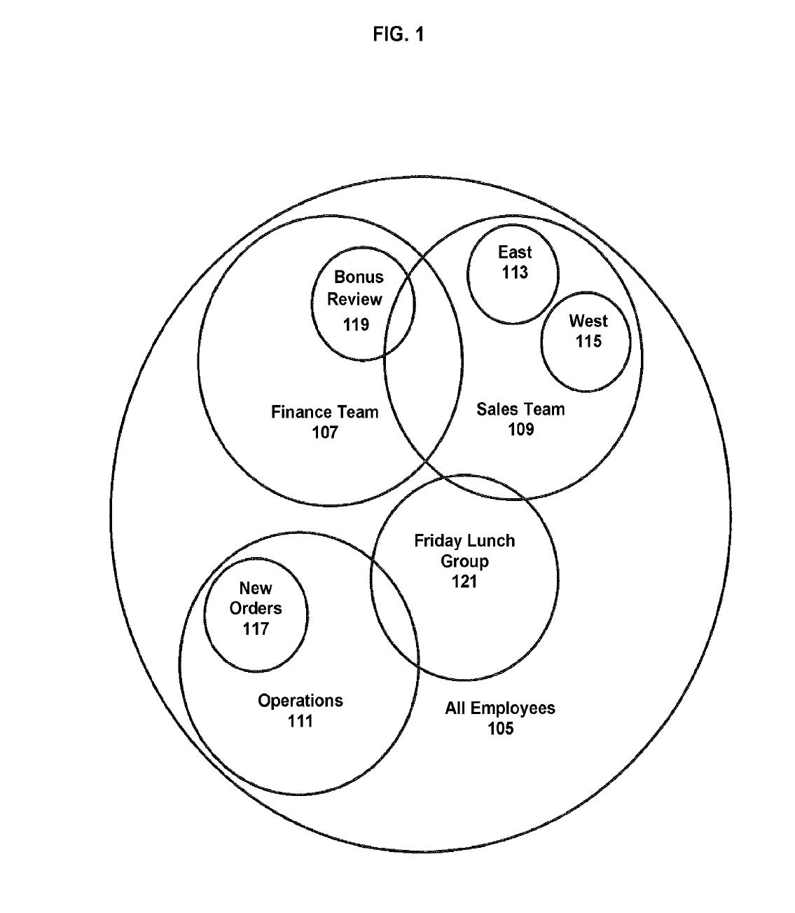

FIG. 1 is a Venn diagram showing an example hierarchy of groupings possible under embodiments of the invention. The business administrator may create a group 105 that involves all employees. Under that top group, the business administrator can then further create a series of subgroups that cover different aspects of the business 107, 109, 111, such as a finance team 107, a sales team 109, and an operations team 111. The owner or administrator of each group or subgroup may then create subgroups 113, 115, 117, under the group he or she manages, e.g., a subgroup for salespersons in east 113 and west 115 sales territories. If a group is configured to do so, each group member can create his or her own subgroup 119, 121 that includes one or multiple members from this group. For example a payroll administrator may create a confidential bonus review group 119, while another employee may create a Friday lunch social subgroup 121. Regardless of hierarchical level, if the group is configured to do so, all members in this group can exchange text or voice messages; make conference calls; share files including documents, images, and videos; create or update a group calendar; create or update group tasks; and track group task progress. Each group member can search historical text messages of this group and search shared group files. A group or subgroup may also be configured for information feeds, i.e., only group members with an administrator role can publish information, and other group members can only view published information appropriate to their group membership such as messages concerning new purchase orders for a new orders operations subgroup 117 tasked with order fulfillment. A user may, of course, belong to multiple groups, as indicated by the overlap of circles in the Venn diagram.

Different types of group may add members by various methods, including invitation-based, password-protected, and QR code-based variants of invitations or passwords. Depending upon the QR code version that can be displayed on a particular model of device, or more likely a lowest common denominator device, the QR code may encode a locator code for message retrievable by any device which scans the QR code and attempts to retrieve the message (e.g., a message ID for a message sent to the enterprise mobile data system by an inviting member, or a URL for a file, message, web page, or the like stored in the enterprise mobile data system by an inviting member) or may directly encode the information required for a user to be added as a member of the group.

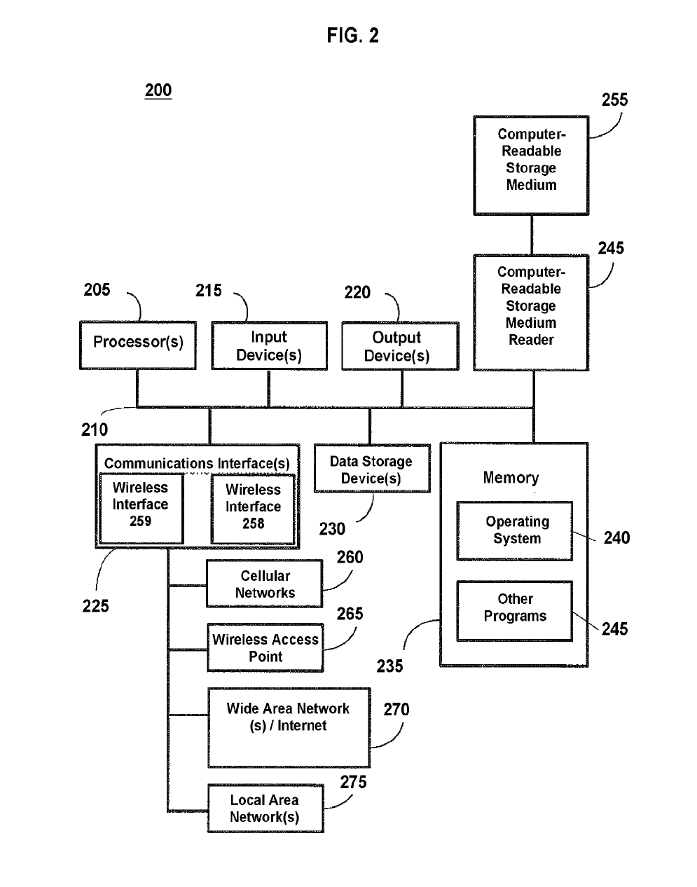

FIG. 2 shows a block diagram of a computer system 200 illustrating one possible hardware configuration to support the disclosed systems and methods. It will be appreciated that the invention may be implemented using alternative hardware configurations. Computer device 200 may be in the form of a desktop computer, a laptop computer, a tablet computer, a server, a virtual server operating on one or more computer devices, a cellular device, a mobile phone, a smart phone, a mobile computer, a mobile device, a handheld device, a media player, a personal digital assistant, etc. including combinations of items.

The computer system 200 includes a processor 205, such as any of the various commercially available central processing units offered by Intel, A M D, and Motorola, coupled to a communications channel 210. Communications channel 210 may include any of several types of bus structure such as a system bus, a memory bus or memory controller, a peripheral bus, and a local bus using any of a variety of commercially available bus architectures designed to effect communication between various components of the computer system. Dual microprocessors and other multi-processor architectures may also be employed as the processor 205. The computer system 200 further includes an input device 215 such as a keyboard or mouse, an output device 220 such as a LCD, plasma, or LED display, a communications interface 225, a data storage device 230 such as a magnetic or optical (read-only or rewritable) disk, or solid state drive, and memory 235 such as Random Access Memory (RAM), each coupled to the communications channel 210. One skilled in the art recognizes that, although the data storage device 230 and memory 235 are shown as different units, the data storage device 230 and memory 235 may be parts of the same unit, distributed units, virtual memory, etc., and that the term “memory” as used herein is intended to cover all data storage media, including ROM and RAM or any memory known by one skilled in the art, whether permanent or temporary. The communications interface 225 may be coupled by wired 258 or wireless 259 interfaces to a cellular telephone network 260, a wireless access point 285, a wide area public network, for example, the Internet 270, and or a local area private network 275, for example an Ethernet LAN. One skilled in the art will readily recognize that data may be transmitted in both wired 258 and wireless 259 interfaces in any number of available protocols. One skilled in the art will recognize that for the purposes of this disclosure, fiber optic transmission of data is a form of wired data transmission, and that wireless data transmission can occur in a wide variety of suitable forms such as acoustic, RF, infrared, and other wireless transmission media.

A basic input/output system (BIOS), containing the basic routines used to transfer information between elements within the computer system 200, such as during start-up, is stored in the data storage device 230 or in memory 235. The data storage device 230 or the memory 235 may also store an operating system 240 such as Microsoft Windows, Linux, Unix, MAC OS, etc. The operating system 240 in the computer system 200 can be any of a number of commercially available operating systems and/or web client systems, and/or open source operating systems, covering the spectrum of consumer electronics devices including but not limited to cameras, video recorders, personal media players, televisions, remote controls, etc., as well as all web client systems including commercial and open source platforms providing thin-client access to the cloud. The data storage device 230 or the memory 235 may store a number of other items, including one or more application programs, other program modules, and program data. Embodiments of the invention may also be implemented on platforms and operating systems other than those mentioned. Embodiments of the invention may be written using Java, C++, C, C#. Perl, PHP or any of a wide variety of commonly available programming languages.

Computer system 200 may intercommunicate with a wide variety of other devices over networks by way of communications interface 225. Computer system 200 may also include additional components such as additional network connections, additional wireless network connections, additional memory, additional processors, and additional communications interfaces. Programs and data may be received by and stored in computer system 200 in alternative ways. For example, a computer readable storage medium reader 245 for removable media, such as a magnetic disk drive dock, a flash media reader, an optical disk drive, or an interface bus device such as USB. Firewire, or eSATA-linked external drive (for, for example, a flash or so-called ‘thumb drive’), may be coupled to the communications channel 210 for reading a non-volatile computer readable storage medium 255, such as a magnetic disk drive, a flash card, an optical disk, a flash drive, a portable storage device, or other devices. The communications interface 225 coupled to communications channel 210 can access data stored on the Internet 270. Thus, the computer system 200 may receive programs or data by the computer readable storage medium 250 or by the communications interface 225 for storage on the data storage device 230 of the system itself.

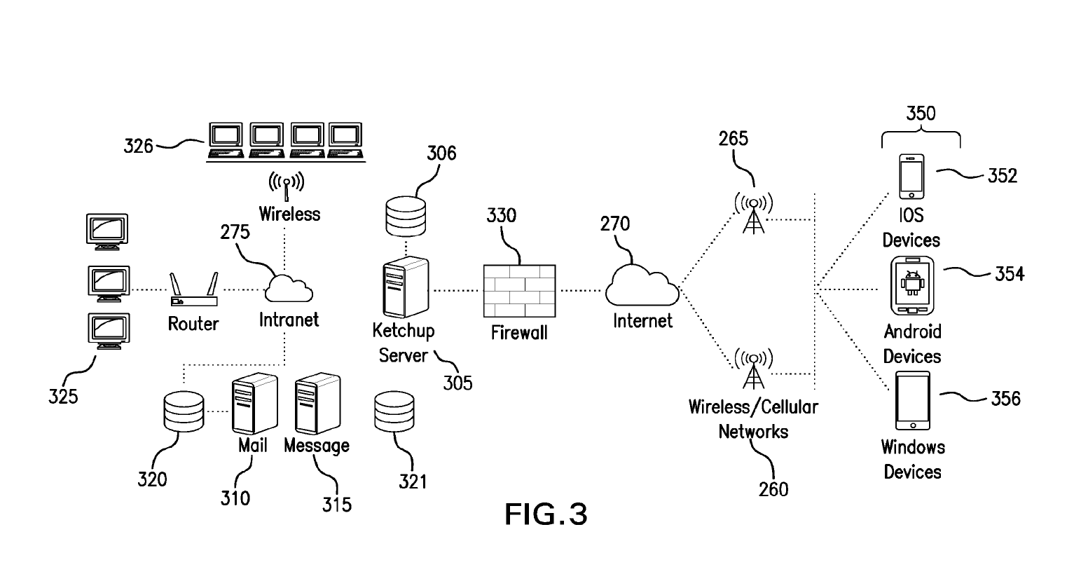

FIG. 3 diagrams the architecture of a unified enterprise mobile data system 300. The enterprise mobile data system server 305 may integrate messaging from an email server 310 and instant messaging server 315. The enterprise mobile data system server 305 has access to system database 306. Email server 310 has access to databases 320 and an instant messaging server 315 have access to databases 321. Each of these secure systems, and any number of internal wired and wireless client computers 325, 326 having an IP address internal to the enterprise, are all located behind an enterprise firewall 330. All contact profiles, communications, and business data are stored within the secure systems behind the enterprise firewall 330.

Access to the enterprise mobile data system server 305 over the Internet 270 or other networks is provided only through firewall 330. The enterprise mobile data system server 305 may be accessed over the Internet 270, or through cellular or other wireless networks 260, 265 by those mobile computing devices 350 registered to access the enterprise mobile data system server 305. The registered mobile computing devices 350 should employ a mobile data messaging system client program to access the enterprise mobile data system server 305. The mobile data messaging system client program employed should be a version compatible with the operating system of the mobile computing devices 350, such as IPhone 352, Android 354, Windows 356, or other operating system based mobile computing devices 350. Alternatively, access to the enterprise mobile data system server 305 over the Internet 335 may be provided to non-mobile computing devices (not shown) over both a wired connection (not shown) to the Internet 270 or through the cellular or other wireless networks 260, 265. Non-mobile computing devices should employ a similarly compatible data client messaging system client program communicating over the Internet 270 (if off-premises) or with an enterprise LAN 275.

As an alternative route of communication to users, the enterprise mobile data system server 305 may also route all communication traffic for a user through the business email server 310. Thus, even an employee who does not use a mobile computing device 350 may still participate in the communications through their business email account without missing any information. When configured to do so for a user or group, the enterprise mobile data system server 305 will forward all group or individual messages related to a user to that user's email account. When enterprise mobile data system server 305 forwards a message, it may set the sender and reply-to addresses in the email to indicate that it came from the system, e.g. mobile_data_system@business.com, and the subject of the email to indicate the receiver (which may be a group or individual contact name) and message type, i.e. $group_name$chat or and $contact_name$chat, and the body of the email will be the message itself. The user may then reply to messages of this type using their business email account. The replying message will go to the enterprise mobile data system server 305 for further processing and distribution as appropriate. Similarly, an employee without a smartphone may post messages to the enterprise mobile data system through the business email system by sending emails to enterprise mobile data system server 305 through its email account (e.g. mobile_data_system@business.com) with special email subject such as:
$group_name$join, $group_name$drop, $group_name$chat,
$contact_name$chat, $group_name$calendar_view,
$group_name$calendar_create. $group_name$calendar_delete,
$group_name$sharedspace_view,
$group_name$sharedspace_upload,
$group_name$sharedspace_delete, $group_name$task_view,
$group_name$task_update, or $group_name$task_create.

Exemplary, easily human-decodable commands such as the foregoing are preferred so as to allow communication with the system through generic email clients, as opposed to specialized application clients which might require installation upon public or guest computers.

All emails that address to mobile data systembusiness.com are routed to the enterprise mobile data system server 305. The enterprise mobile data system server then extracts the destination group or individual contact from the email subject, and extracts the message type. According to the message type, the enterprise mobile data system further extracts the message itself from the email body. The formats of the email body corresponding to different message types are listed as follows.

Email Subject: $group_name$join

Email Body: password

Email Subject: $group_name$drop

Email Body:

Email Subject: $group_name$chat

Email Body: any free text

Email attachment: any audio file and/or any image file and/or any video file

Email Subject: $group_name$calendar_view

Email Body:

Email Subject: $group_name$calendar_create

Email Body: title: department meeting

location: Room 3033, Building CL, KSU

starts: Jan. 1, 2014 10 am

ends: Jan. 1, 2014 11 am

Email Subject: $group_name$calendar_delete

Email Body: event_d: 0010

Email Subject: $group_name$sharedspace_view

Email Body:

Email Subject: $group_name$sharedspace_upload

Email Body:

Email attachment: documents and/or images and/or videos

Email Subject: $group_name$sharedspace_delete

Email Body: document_id: 0005

Email Subject: $group_name$task_view

Email Body:

Email Subject: $group_name$task_update

Email Body: task_id: 0020

progress: 30%

comment: good progress

Email Subject: $group_name$task_create

Email Body: title: task #3

description: new task

start: Aug. 1, 2014

end: Aug. 10, 2014

Email Subject: $group_name$task_delete

Email Body: task_id: 0020

It will be appreciated that data appearing after entries such as title: event_d:, document_d:, task_id:, etc. are exemplary content. If the enterprise mobile data system server 305 receives an email with improper subject or email body, it will response with an email that contains all the templates for different group communications that the user can directly copy and paste.

In one embodiment the enterprise mobile data system includes installation and configuration software applications that allow the administrator to build a data pipeline that loads pre-existing contact information from databases 320 of the email server 310, and/or the databases 321 of the instant messaging server 315, or employee/student information system into enterprise mobile data system server 305. These installation and configuration software applications may be of any convenient method, including graphical user interfaces (GUI), or command line interfaces. Contacts may be populated and maintained by performing ETL (exchange, transform, and load) processes with one or more of these systems.

Users of the unified enterprise mobile data system 300 from a mobile data messaging system client program on any type of mobile computing device 350 are presented with a number of graphical user interface (GUI) screens representing the full range of system functions available to that user.

In one embodiment, the unified enterprise mobile data system 300 is implemented in a university setting. In this embodiment, the user may be a student, a faculty member, an administrator, a staff member, etc.

The unified enterprise mobile data system 300 separates groups from individual contacts into different screens. The group structures that a user sees in the group screen generally match the business structures the user is working with. For example, a university professor performs login on the unified enterprise mobile data system 300 and accesses a group level screen and sees the following groups: university group, department group, committee group, class groups, etc. Once the user selects a group, he or she sees messages including text and voice messages just for this group. Each group is associated with a shared data store. Any group member seeking to share any documents with the group need only to upload that document to the shared data store. Any group member can access any document in the shared data store for the group. Each group is also associated with other resources, e.g., a group calendar and/or a task tracker. A group provides a unified entry to access all group-associated resources.

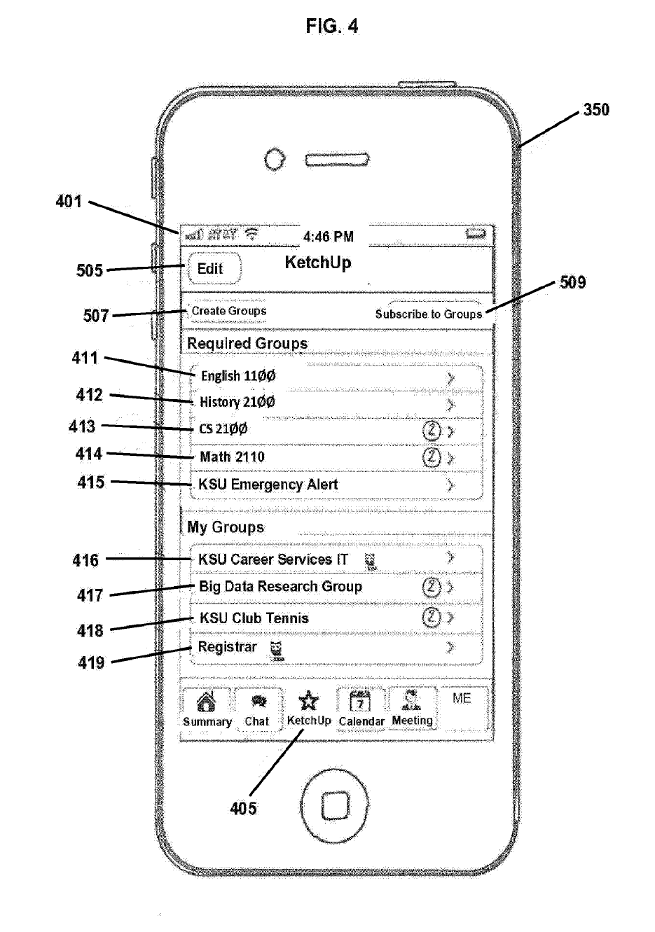

FIG. 4 shows a GUI 401 showing a user's group list displayed on an example mobile computing device 350. Selecting the branded enterprise mobile data system button 405 (e.g., the “Ketchup” button) displays to the user all the groups 411-419 with which the user is affiliated. A category of “Required Groups” may show all the official business groups that the user is part of; and a category of “My Groups” shows those groups that a user has created or In which a user is voluntarily subscribed, with the number besides each group indicating the number of unread new messages in the group. The user may edit or unsubscribe from the groups listed in the latter category by pressing the “Edit” button 505; create a new group by pressing the “Create Group” button 509; or join a new group by pressing the “Subscribe to Groups” button 509.

Under “Required Groups,” there may be system-generated groups, as described earlier, corresponding to, for example, courses in which the user is enrolled. To identify such groups, the unified enterprise mobile data system 300 may be linked to a registrar office's course enrolment system by an ETL process and, for each student who registers for courses such as English 1100 411, History 2100 412, CS 2100 413, and Math 2100 414, add the user as a member of a corresponding course group. Under “My Groups,” there may also be enterprise (university-wide) information feed groups, public groups, etc. that the user voluntarily subscribes to and follows, e.g., KSU Career Service IT 416, and Registrar 419. There may also be individual user-initiated groups, such as, for example, the Big Data Research Group 417 and the KSU Club Tennis 418.

For information feed groups such as KSU Career Service IT 416 and Registrar 419, the user can view messages posted by university officials (one or more group administrators), but may not post messages to these groups. For other groups, all users can participate in exchanging messages. In this example, an exemplary student member would be unable to post to the information feed groups 416 and 419, while another exemplary member, a registrar administrator, would be able to post to registrar group 419, but not to KSU Career Service IT group 416.

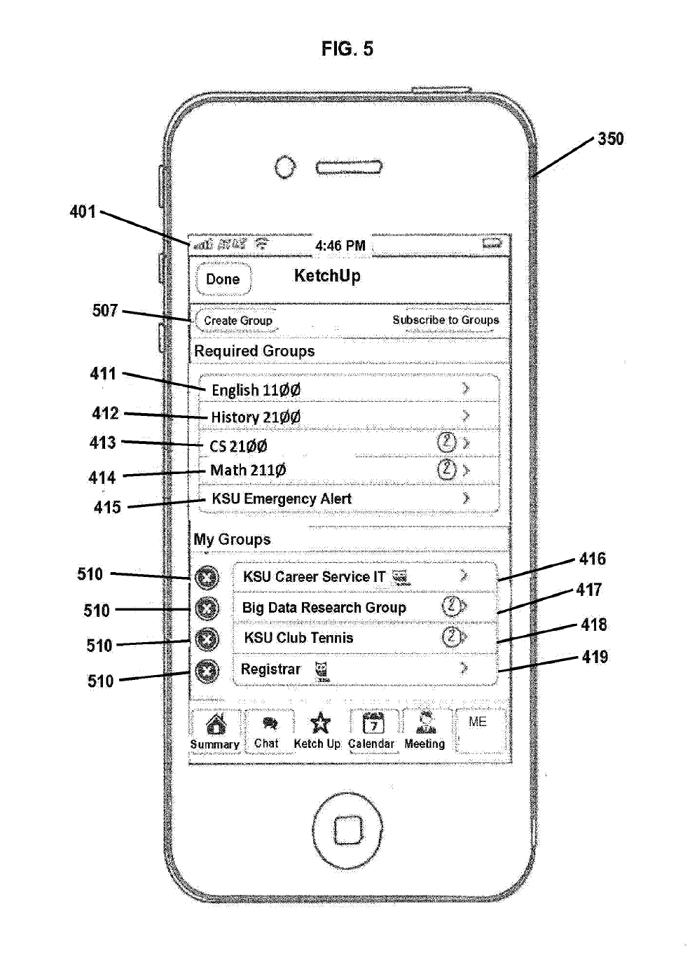

Because the unified enterprise mobile data system 300 is group-centric, group management from the GUI 401 is simple. FIG. 5 shows a GUI 401 showing a user's group list available for editing displayed on example mobile computing device 350. A user may select the “Edit” button 505 (shown in FIG. 4) which enables the user to access functions to create, edit, or drop a group. The user may access the function to create a group by selecting the “Create Group” button 507. If the user has permission, the user may access the function to edit a group by selecting the group 411-419 he or she desires. The user may drop a group by selecting from the “X” drop buttons 510 that drop button adjacent to the group 416-419 he or she seeks to drop. Dropping a group does not dissolve the group, but merely dissociates the user from it. When the next to last or last administrator in a group drops the group, a message may be sent to the last administrator or enterprise mobile data system's system administrator, respectively. Groups without any administrator members may be kept for a predetermined time period, and may be purged from the enterprise mobile data system after that time period has lapsed.

The enterprise mobile data system may provide multiple ways to join a group, depending on the nature of the group.

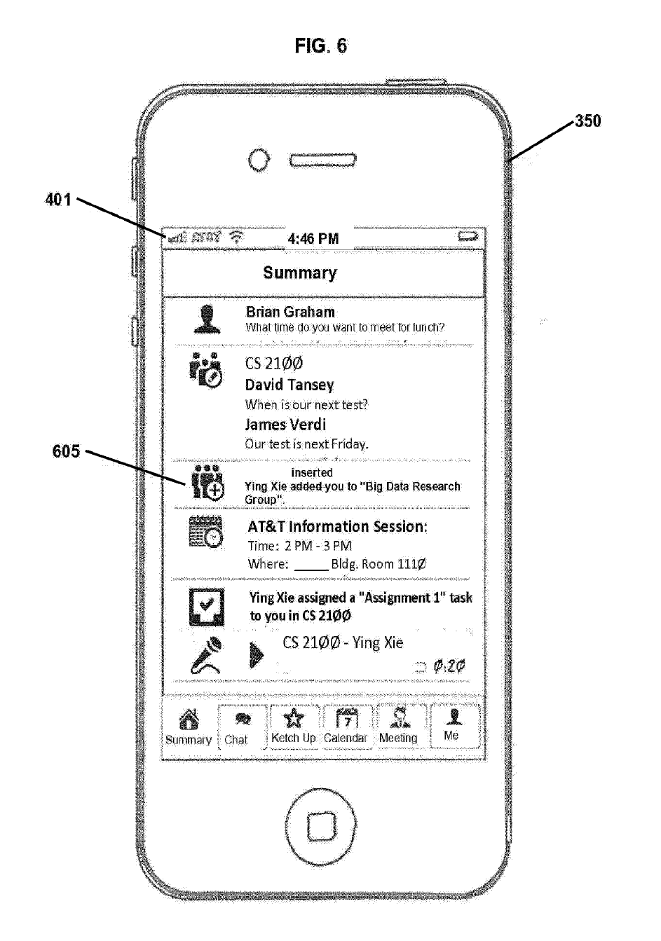

Joining a group may be accomplished through an invitation message sent to the user through the unified enterprise mobile data system 300. FIG. 6 displays a GUI 401 on an exemplary mobile computing device 350 showing a summary of the users account activity. This summary contains all new messages for the user from related groups and friends, events alerts from related calendars, and events such as invitations to join a group. For example, an invitation message 605 shows the user that he or she was invited to join the group “Big Data Research Group” by fellow user Ying Xie. Depending on the users account settings and the settings of the group, the user may be added to the group automatically at the time of invitation, or may need to confirm addition to the group. If the user is required to confirm addition to the group, selecting the invitation message 605 will present the user with a confirmation dialog (not shown) in which the user may accept, decline, or postpone the invitation response.

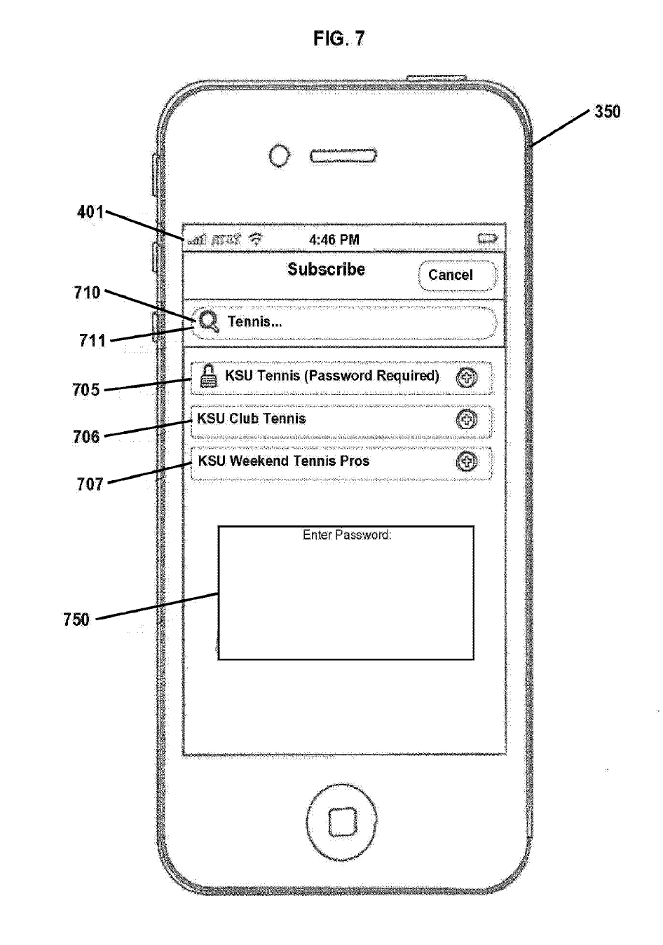

Joining a group may be accomplished by a search and selection from among those groups visible to the user within the unified enterprise mobile data system 300. FIG. 7 shows a GUI 401 showing a search results 705, 706, 707 of available groups relating to search keyword “tennis” displayed on example mobile computing device 350. To search for available groups, the user inputs the search term, e.g., “tennis”, into search box 710, and initiates the search. The search may be automatically initiated, i.e. a “live search,” or may be manually initiated by, e.g. typing enter on the virtual keyboard (not shown) of the example mobile computing device 350 or by selecting the search icon 711. Pressing the + button beside a result, e.g., KSU Club Tennis 706, adds the user to the group. Some groups in the search results may be password protected, e.g. “KSU Tennis” 705. Upon selecting a password protected group from the search screen, the GUI may presents the user with a password prompt 750 to prevent unauthorized access to restricted groups.

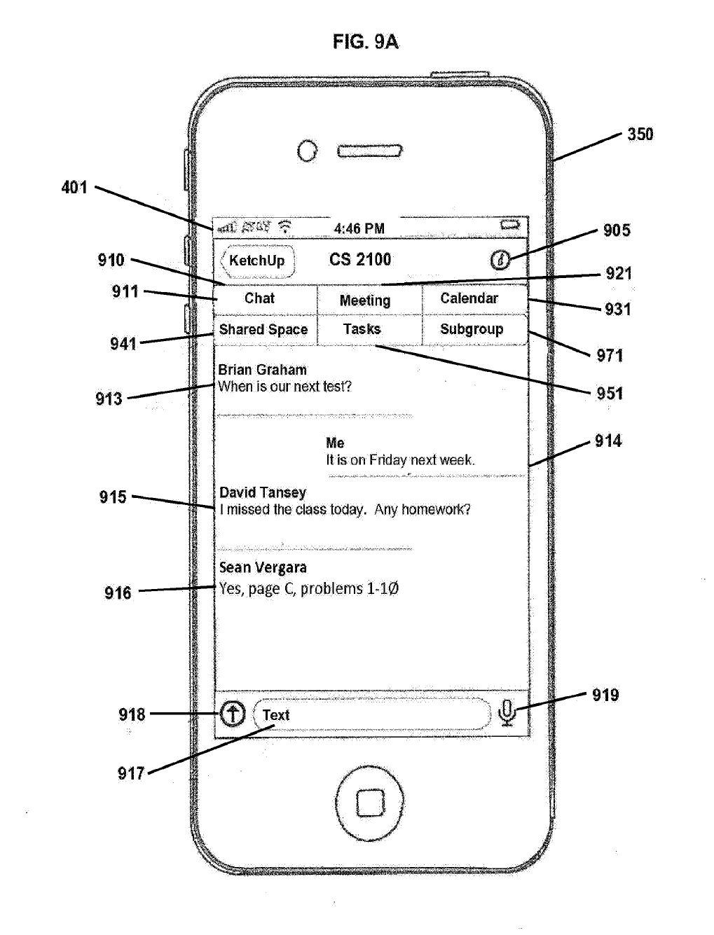

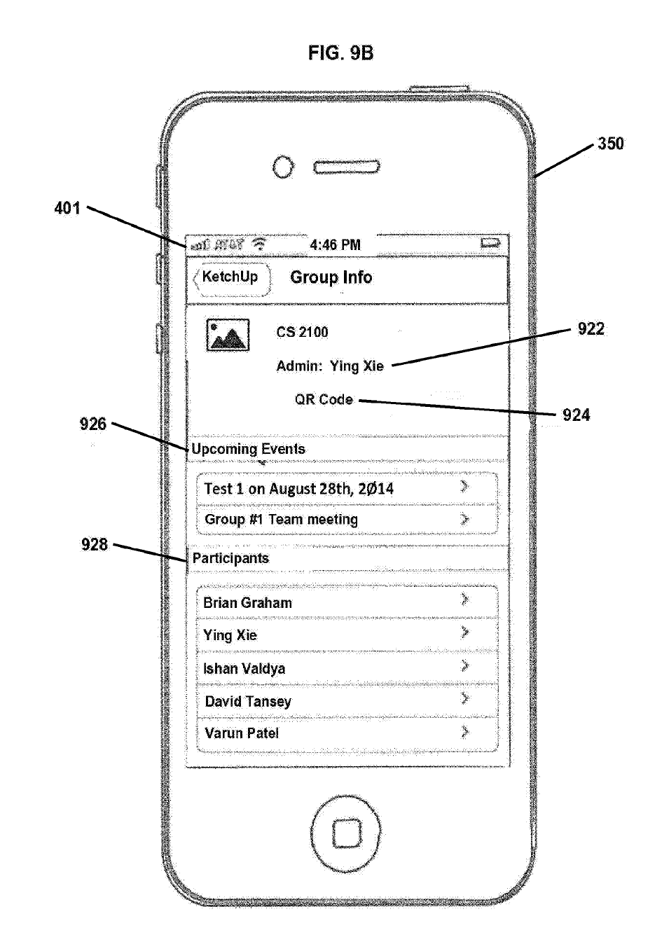

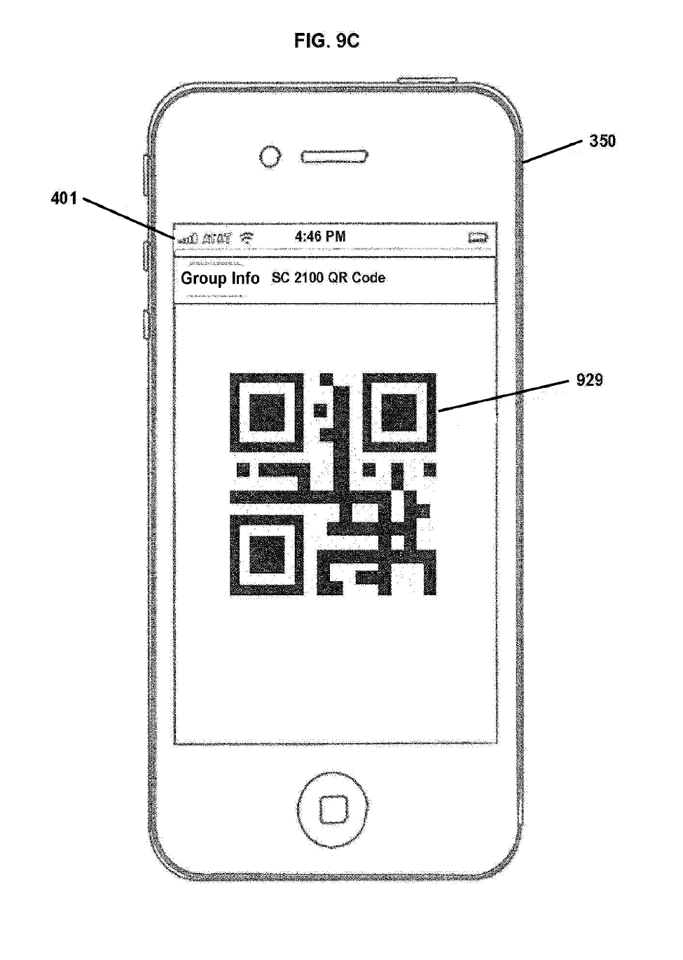

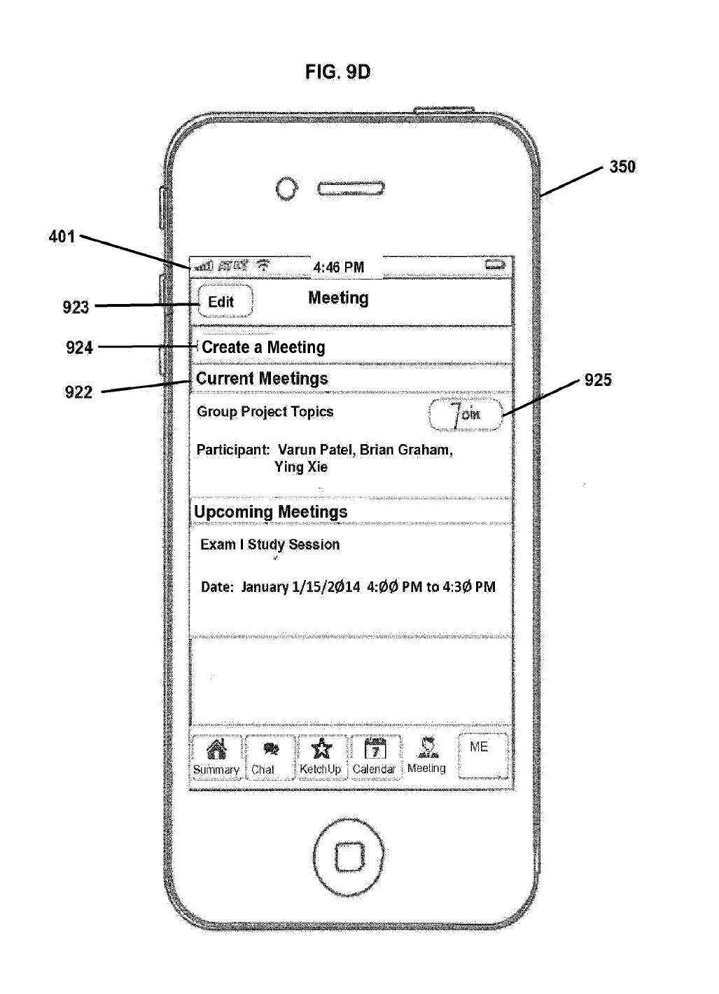

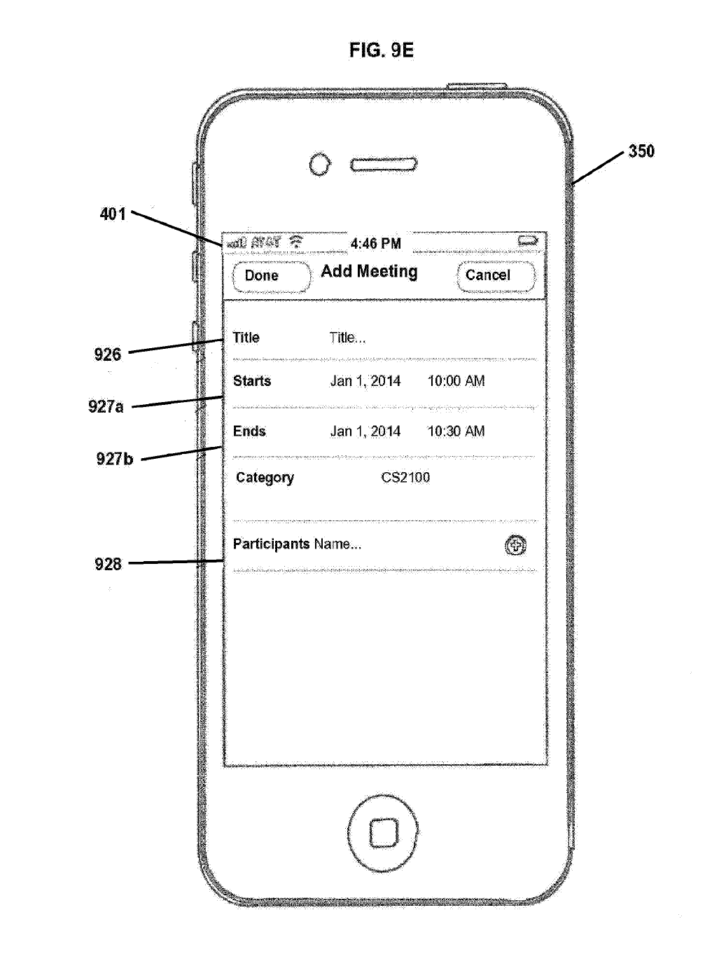

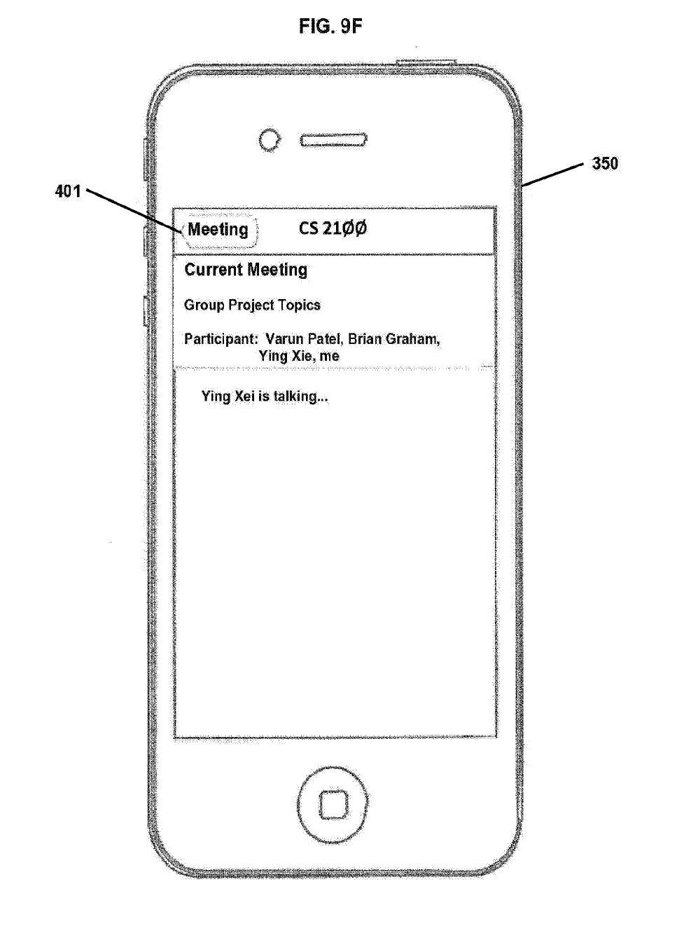

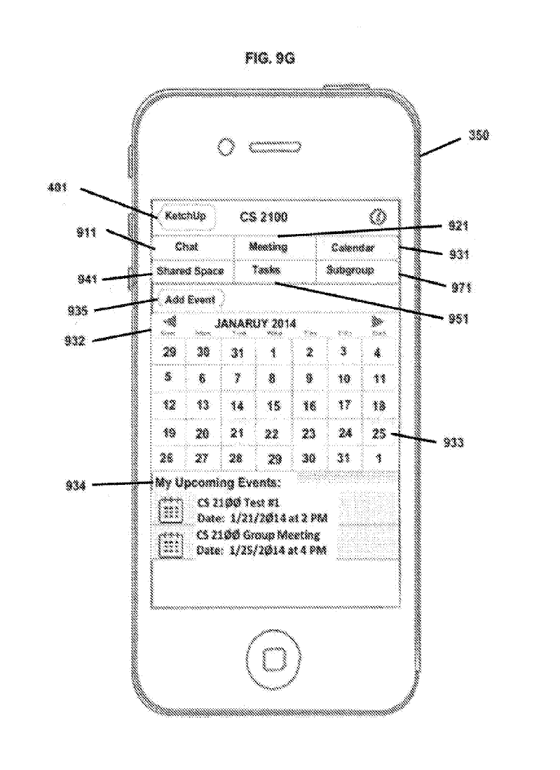

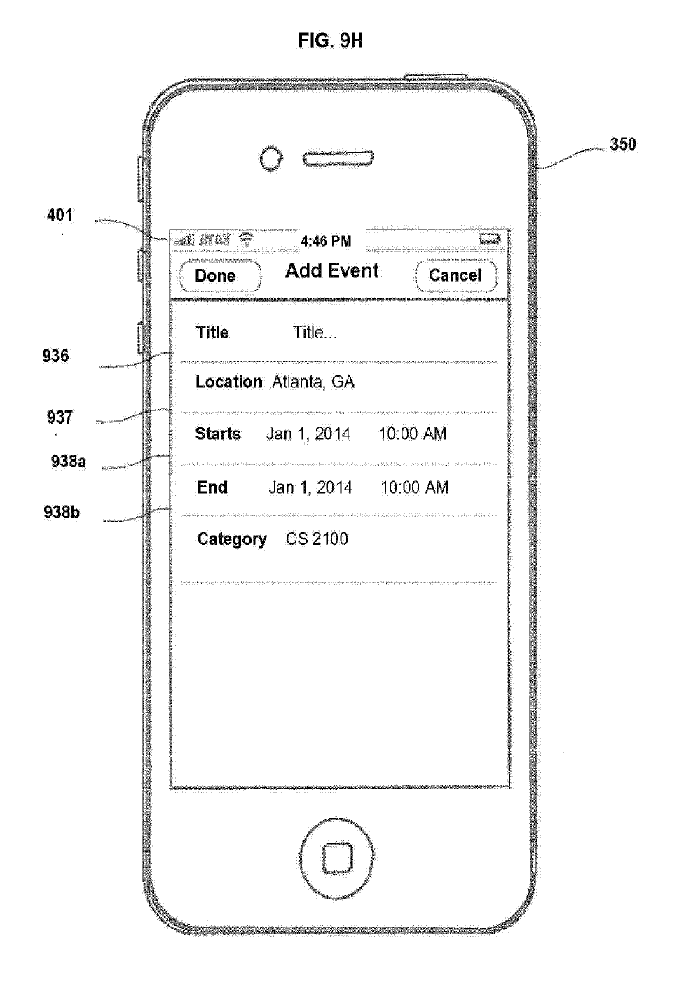

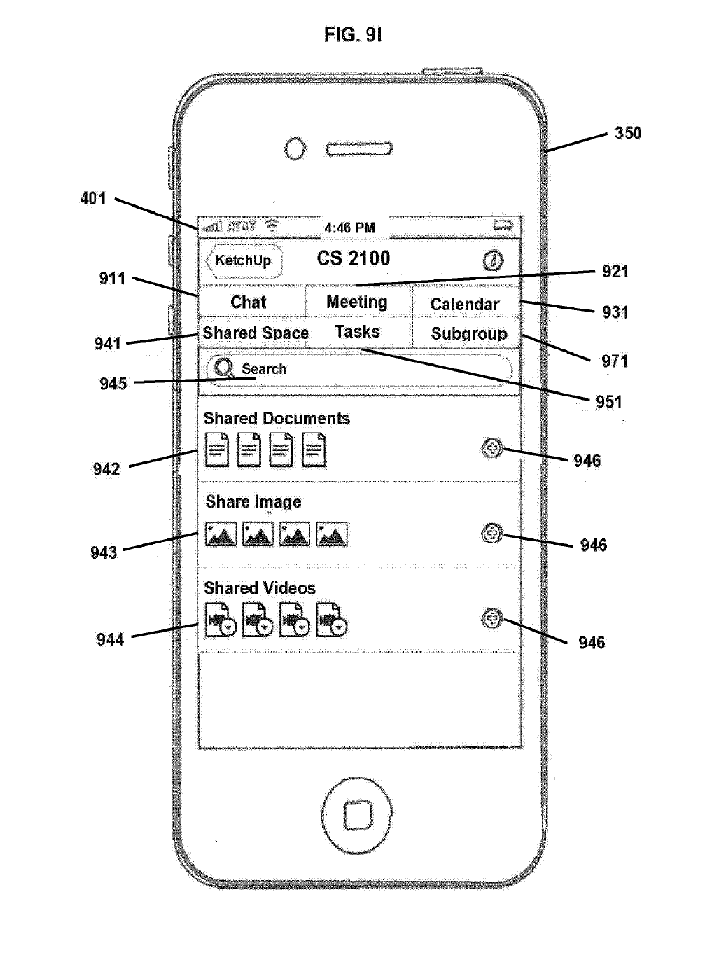

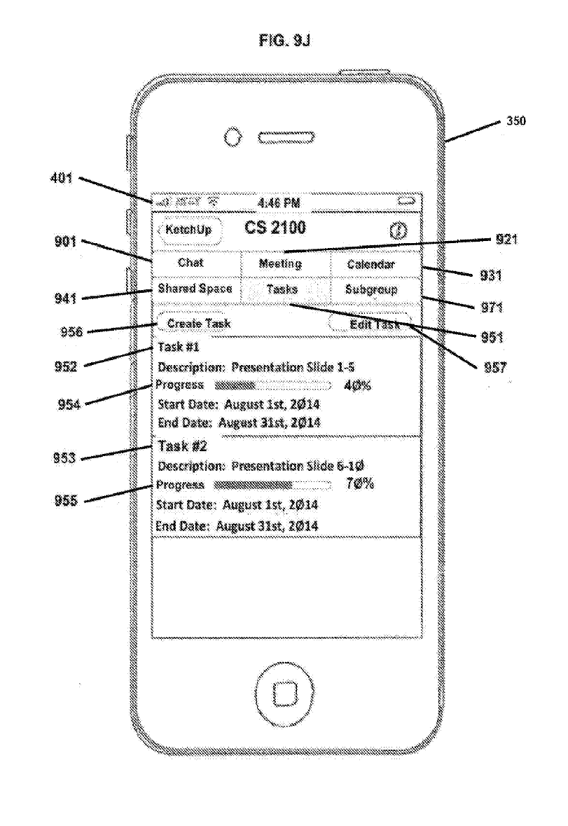

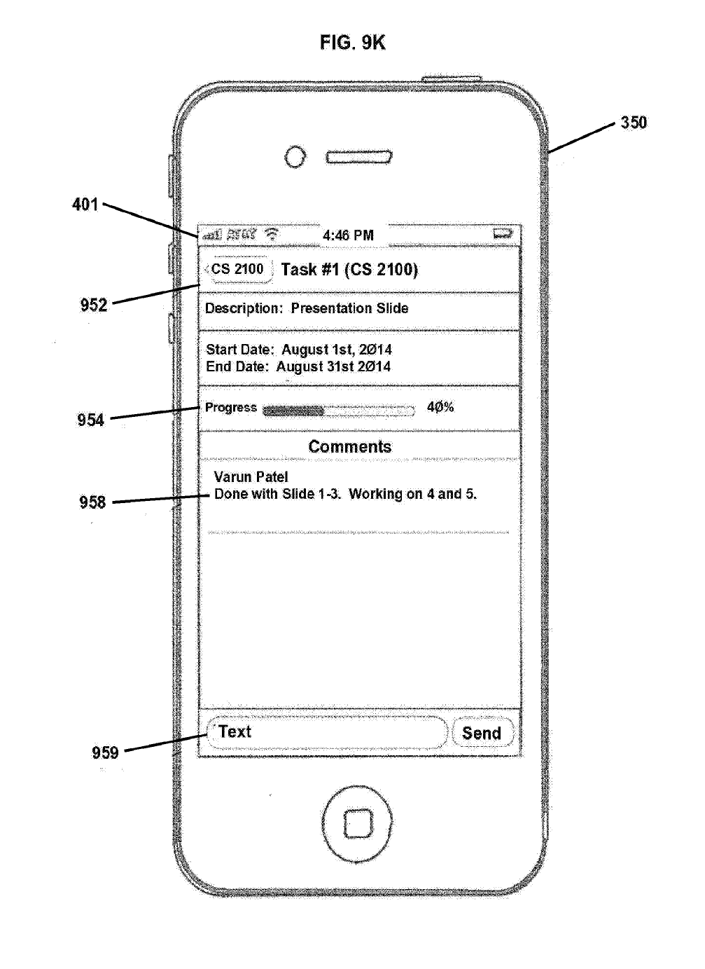

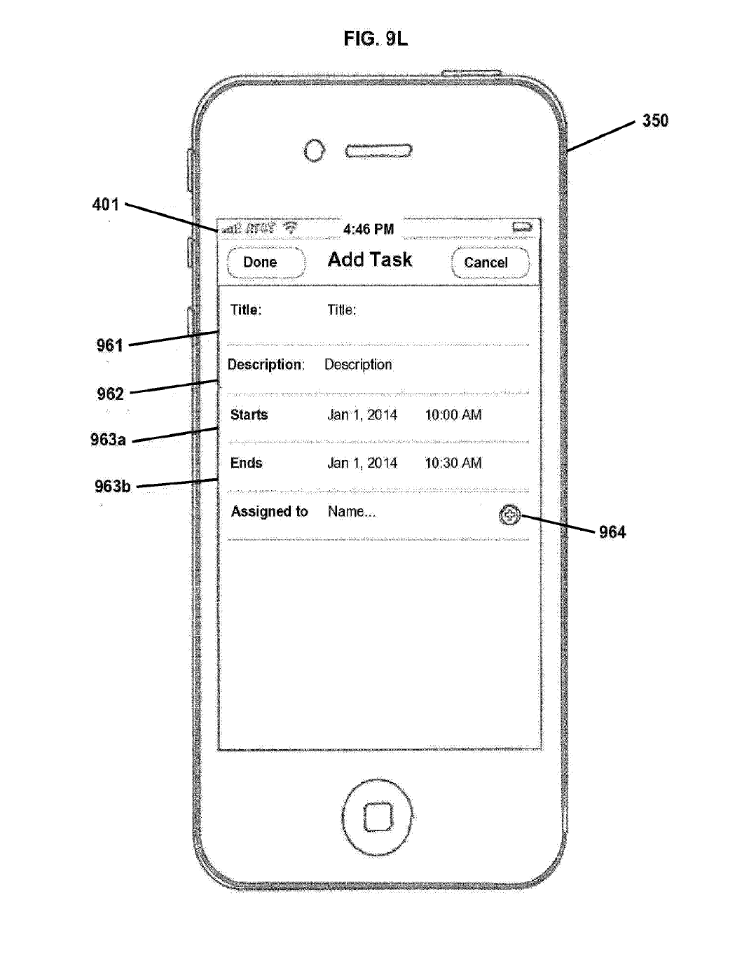

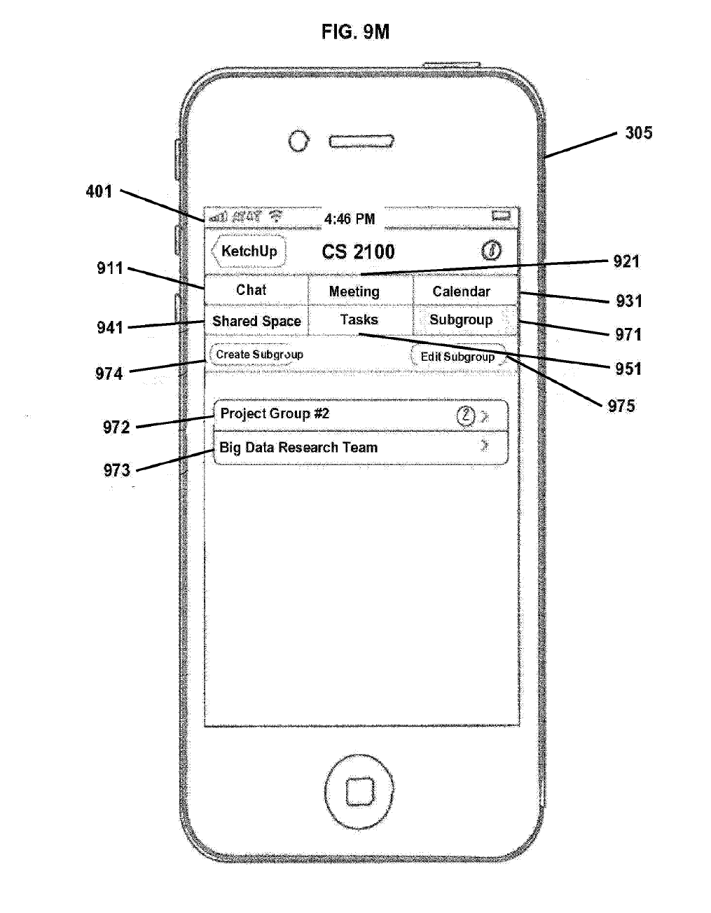

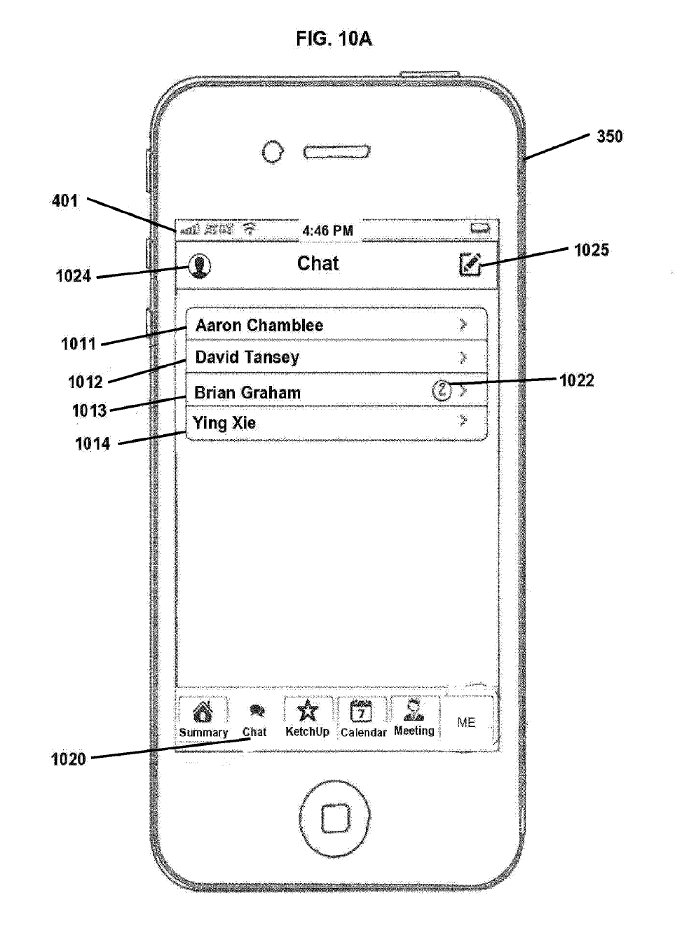

Joining a group may be accomplished by scanning a QR code 929 (shown in FIG. 9C) that may be displayed within a GUI 401 of a first mobile computing device, and scanned by the camera of a second mobile computing device, for processing by the scanning mobile computing device. The QR code is generated for each group when the group is created. A group administrator has access to the QR code of the group (FIG. 9B). If it is set so, any group member may have access to and display the QR code of the group. A scan of the QR code directs the mobile data messaging system client program of a second users mobile computing device to automatically add the second user to a group, for example “KSU Tennis Weekend Pros.” The QR code may alternately be printed or exported by a fixed system client program for use in posters, flyers, directories, or other printed materials, or displayed in any other way QR codes are known to be effectively displayed.

Joining a group may be accomplished through the business email system hosted on business email server 310. For example, an employee lacking a smartphone can join a group by sending emails to business email server's 310 email account (e.g. mobile_data_system@business.com) with special email subject and body, such as subject: $group_name$join and email body: password.

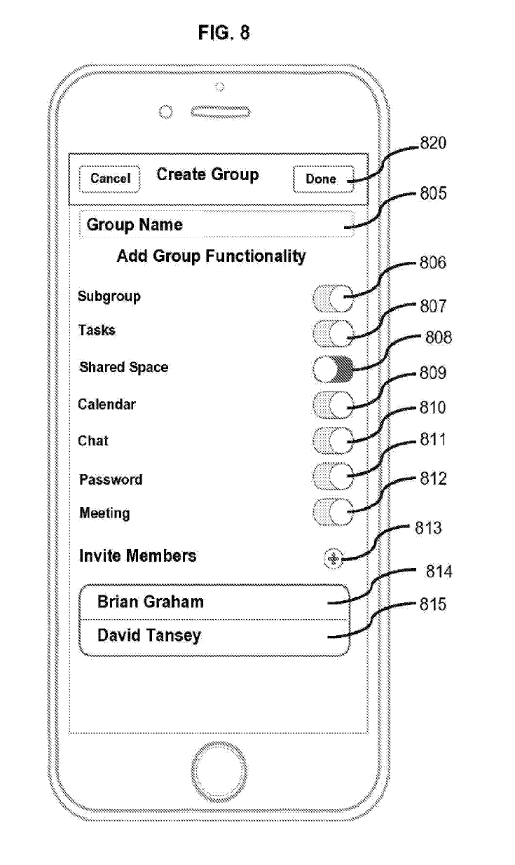

Users may create groups from their mobile computing devices 350. FIG. 8 shows a GUI 401 showing the basic input parameters for creating a group displayed on example mobile computing device 350. The user creating the group must specify a group name in name field 805, and select whether or not this group: allows subgroups by switching toggle button 306; allows task management by switching toggle button 807; has shared space by switching toggle button 808; has a group calendar by switching toggle button 809; has a group chat function by switching toggle button 810; requires a password to join by switching toggle button 811, or has the group meeting function by switching toggle button 812. If a group does not allow the chat function, the group is an information feed group, which only allows the group administrator(s) to publish messages to the group. Switching the password toggle button 811 to on to require a password prompts the administrator to set a password for the group. If the group does not require a password to join, the group is a public group that every user of the system can join. If the group does require a password, the group is a private group. The user may, but is not required to, indicate fellow users 814, 815 that the user wishes to invite to join the group by selecting the “+” “invite members” button 813. Selecting the “+” “invite members” button 813 presents the user with a dialog in which the user may search for and select users to invite. Selecting the “Done” button 820 submits the group parameters to the enterprise mobile data system server 305 for creation of the new group and, if indicated by the user, messaging to invited users. Depending on enterprise mobile data system settings and the users permissions, the enterprise mobile data system server 305 may automatically create the group, or may submit the group for administrative review and approval of creation. Once an invitee has been invited to an automatically-created or approved group, the invitee will be part of that group and an invitation message will be sent to the invitee. That invitee can later choose to withdraw from a group by deleting the group from the user's group list, as discussed above.

Selecting any of the groups 411-419 that the user is associated presents more detailed functions and information specific to that group. FIGS. 9A-M show examples of such functions and group information. As one example, for a selected group CS 2100, 413, FIG. 9A shows a GUI 401 on the example mobile computing device 350 displaying a group messaging chatting area. The top of the GUI 401 displays a ribbon 910 of tabs indicating the six primary group functions. Selecting the first tab 911 labeled “Chat” accesses the messaging area of the exemplary group CS 2100. As the GUI 401 displays the messaging area in FIG. 9A, the first tab 910 is highlighted. All persons in the group can see messages 913-916 posted by group members to the meeting area. Users may also post messages themselves by entering their message in text box 917, and submitting it to the group by selecting the “Send” button 918. Users may also record and post audio messages in the main area by selecting a recording button 919, and as well as play audio messages (not specifically shown) by selecting the message. Selecting an information button 905 in the GUI 401 allows the user to access additional detailed information specific to that group, shown in FIG. 9B, such as the name of the group administrator 922, a prompt 924 to display a OR-code encoded invitation or password to subscribe to the group (if permitted by the group settings), a list of upcoming events 926 for the group, and a list of subscribers 928 participating in the group. In particular, selection of the QR code prompt 924 may display a QR code 929, like that shown in FIG. 9C, on the screen of a first group subscriber's device, which may be scanned by the camera of a prospective subscriber using the prospective subscriber's mobile computing device, and processed by that device (e.g., to extract group and/or password information, to navigate to a URL which causes the enterprise mobile data system server 305 to subscribe the prospective subscriber to a group, etc.) to add the other user as a group subscriber. The list of upcoming events 926 may include both scheduled meetings, such as those described below, and scheduled events, such as, to continue the university theme, course start dates, drop dates, end dates, and test or examination dates.

Selecting the second tab 921 (FIG. 9A) labeled “Meeting” accesses the meeting area of the exemplary group CS 2100. FIG. 9D displays a GUI 401 with a list of scheduled meetings 922 including both current and upcoming meetings. The user may edit the listed meetings 922 by pressing the “Edit” button 923; create a new group by pressing the “Create a Meeting” button 924; or join a currently scheduled meeting (synchronized group meeting) by pressing the “Join” button 925. A synchronized group meeting may include features such as a multiple party voice teleconference function (e.g., VoIP teleconferencing), a document sharing workspace, etc. as a substitute or complement to an in-person meeting. The “Edit” button functions similarly to the “Edit” button 505 (FIG. 4) for groups, allowing a subscribing user to delete a meeting from the listed meetings 922 by selecting an “X” delete button (not shown in these figures) adjacent to the meeting he or she seeks to delete. Alternately, the subscribing user may select a meeting from the listed meetings 922 (FIG. 9D) to alter the details of the selected meeting. FIG. 9E displays a GUI 401 for editing or, in this illustrated example, creating a new meeting, where the user may change or specify the title 926, start and end times 927a and 927b, and participants in the meeting 928. The GUI 401 may display a non-editable group name as a title or data field to provide context to the user.

FIG. 9F shows a GUI 401 for users who have joined a currently scheduled meeting, using their mobile computing devices 350, to hold a synchronized group meeting.

Selecting the third tab 931 labeled “Calendar” accesses a calendar display specific to the selected group. FIG. 9G shows a GUI 401 displayed on example mobile computing device 350 with a graphical “group calendar” 932 of exemplary group CS 2100. Days having scheduled events or meetings may include a highlight 933, such as a circled date, a boldfaced date number, a colored date block, etc., and selecting any date on the calendar reveals a list of all group events occurring on that date. The display may also include a list 934 of scheduled events and meetings so as to provide more detailed information such as titles, times, and immediate visibility of next-occurring events or meetings which fall on a subsequent calendar month. Selecting the “Add Event” button 935 allows the user to add an event with date, title, and description, to the group calendar. Notifications of calendar additions are sent to the summary screens (see FIG. 6) of all group members upon finalization. The event is stored in the enterprise mobile data system server 305 upon finalization. FIG. 9H displays a GUI 401 for adding such an event, where the user specify a title 936, location 937, and start and end times 938a and 938b. The GUI 401 may display a non-editable group name as a title or data field to provide context to the user.

Selecting the fourth tab 941 (FIG. 9A) labeled “Shared Space” accesses a data store specific to the selected group. FIG. 9I shows a GUI 401 displayed on example mobile computing device 350 showing the shared space or data store of the exemplary group CS 2100. The shared space provides access to documents 942, images 943, videos 944 that any group member can access. Depending on user and group permissions, the user may or may not be able to edit or delete such items 942-44. Large collections of items may be searched using a search box 945. While a division between documents 942, images 943, and videos 944 is made for convenience in this embodiment, other categorizations and compatibilities are included including more or less granular categorization of shared items, and including other file types such as audio, CAD, or generally any computer file type. New documents 942, images 943, and/or videos 944 may be added to the group shared space by selecting the plus icon 946 besides the respective category or, where categorization is not used, within a generic document collection.

Selecting the fifth tab 951 labeled “Tasks” accesses a task list or “to-do list” specific to the selected group. FIG. 9J shows a GUI 401 displayed on example mobile computing device 350 showing the task list of exemplary group CS 2100. The task list associated with a group allows users to assign tasks 952, 953 to group members and track task progress. Progress toward completion of current tasks 952, 953 is indicated by progress bars 954 and 955, respectively. Selecting the “Create Task” button 956 presents the user with a menu for entering input parameters to create and assign a new task, while the “Edit Task” button 957 functions similarly to the “Edit” button 505 for groups, allowing the user to delete a task by selecting an “X” delete button (not shown in these figures) adjacent to the task entry he or she seeks to delete. Alternately, the user may select a pre-existing task to edit the details of that task. FIG. 9K shows a GUI 401 for editing a task where the user lacks permission to delete or change the details of the task. The user may, however, contribute a comment 958 to the task using a text entry box 959 as well as view other user-submitted comments. The user may also alter the progress indicator 954, e.g., by dragging across the progress indicator bar, to alter the reported progress towards completion. FIG. 9L shows a GUI 401 displayed on example mobile computing device 350 with a menu for creating a task and assigning that task to group members. The task-creating user enters the name of the task at text box 961, a description of the task at text box 962, and start and end dates at text boxes 963a and 963b. Group members are assigned to the task by selecting the “Assigned to” plus icon 964 and selecting users from a presented dialog of users. The users presented for selection in the dialog may be limited to members of the group or subgroup. Selected users are notified of their assignment by the unified enterprise mobile data system 300 when the task is finalized, and the task is stored in the enterprise mobile data system server 305 upon finalization. Selecting the “Edit Task” button 957 shown in FIG. 9J presents the group administrator(s) and task-creating user with a similar menu including comments 958 and text entry box 959, while other users assigned to the task are presented with the more limited menu of FIG. 9K.

Selecting the sixth tab 971 labeled “Subgroup” accesses a menu for displaying, creating, and editing/deleting subgroups. FIG. 9M shows a GUI 401 displayed on example mobile computing device 350 showing two exemplary subgroups, 972 and 973, previously created within group CS 2100. For example, continuing with the university theme, a group composed of students of a class may create subgroups such as “Project Group #2” 972 for course project teams within the class and “Big Data Research Team” 973 for special interest, course-related discussion. Creating, editing, managing, and joining subgroups within a parent group or subgroup is substantially the same as the management of higher-level groups as previously discussed with reference to FIGS. 4, 5, and 8, by the “Create Subgroup” button 974 and the “Edit Subgroup” button 975.

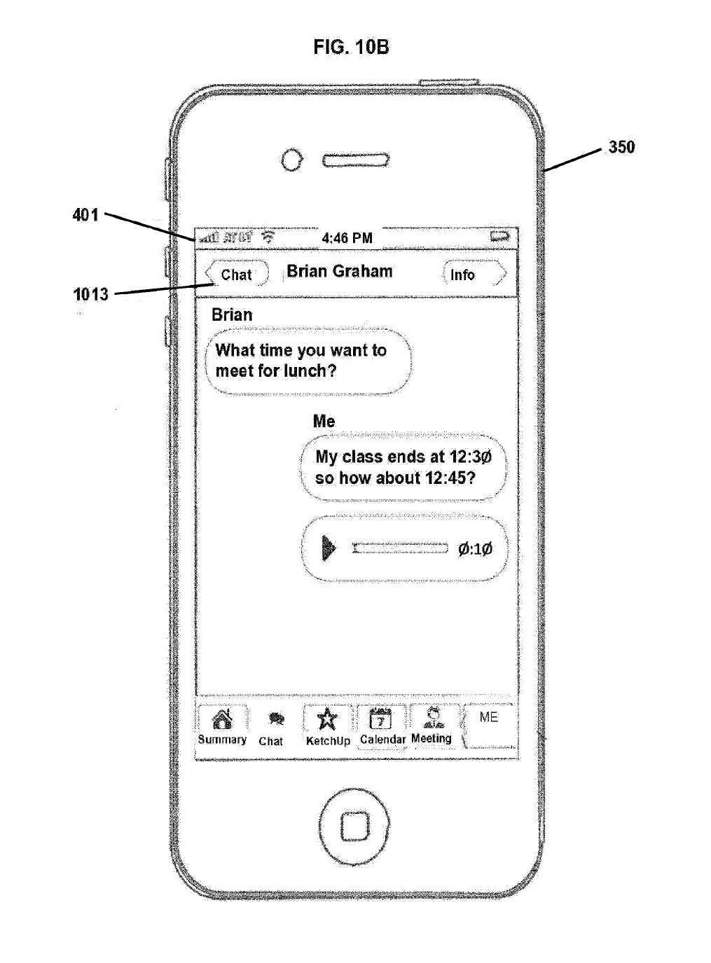

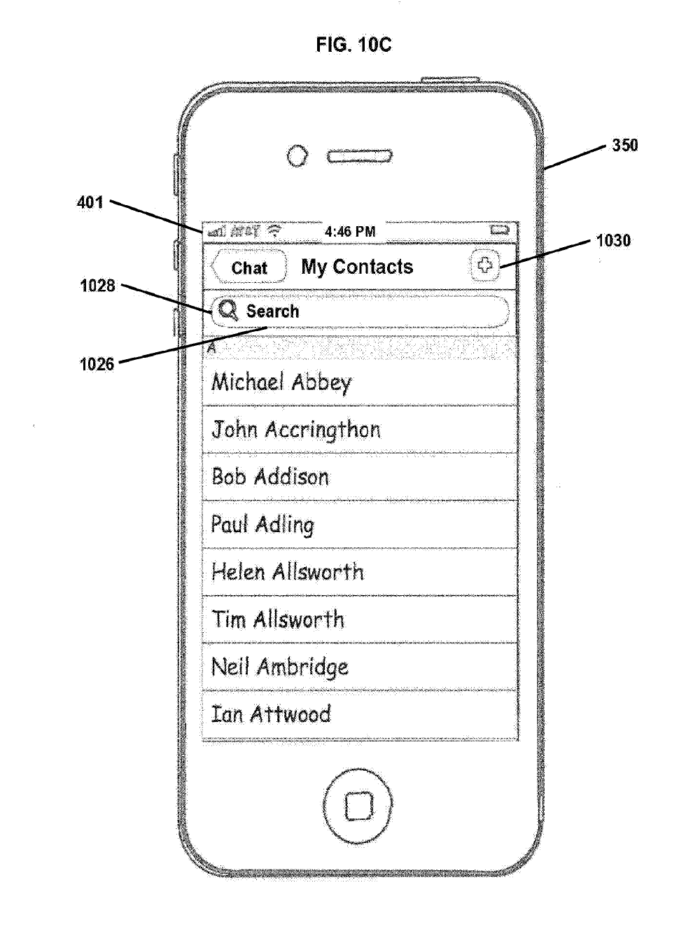

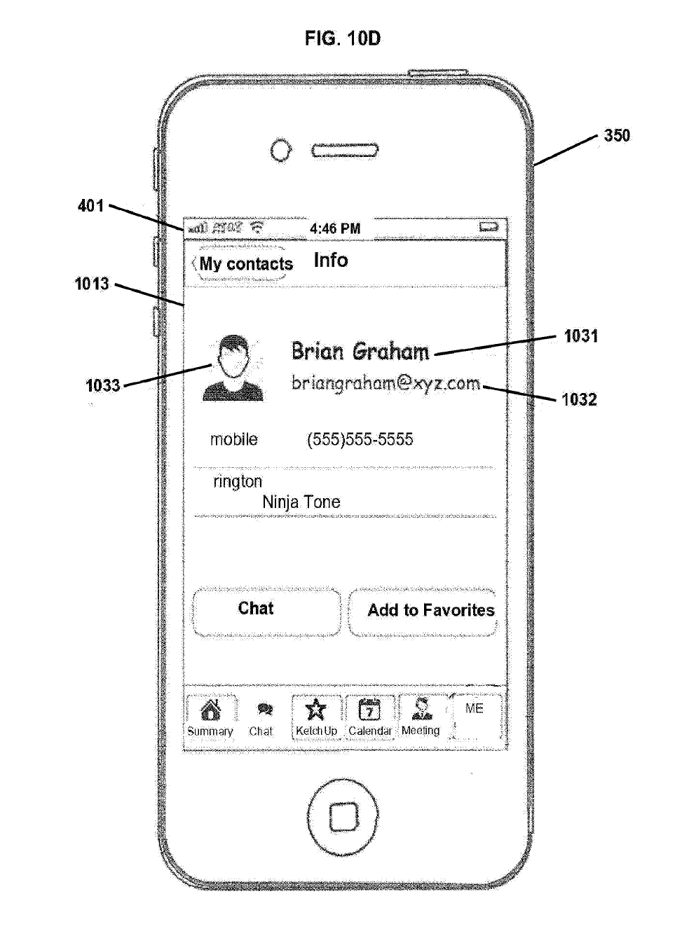

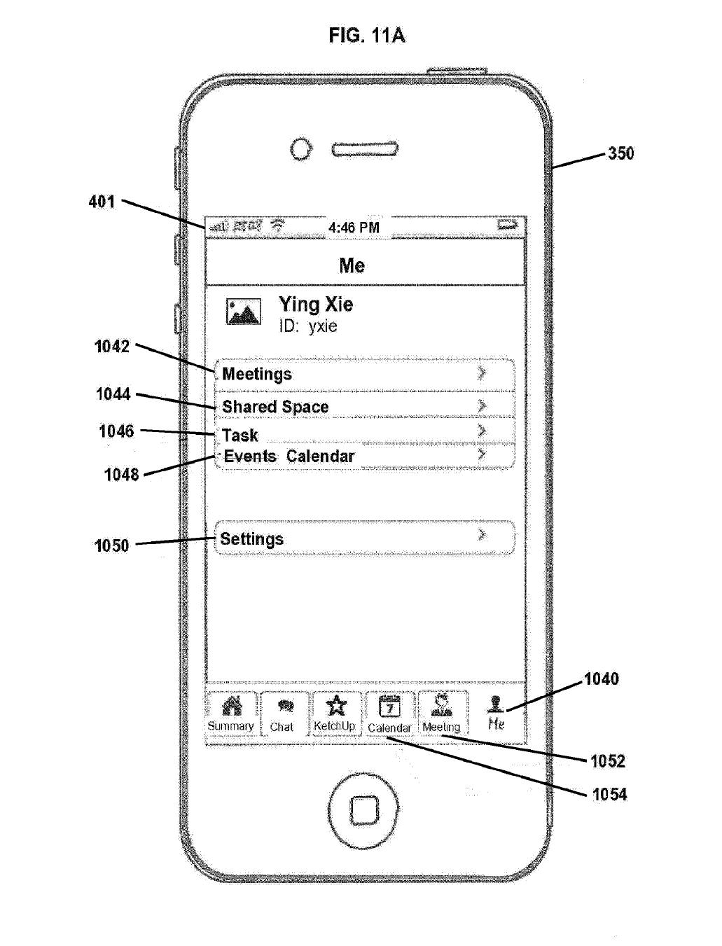

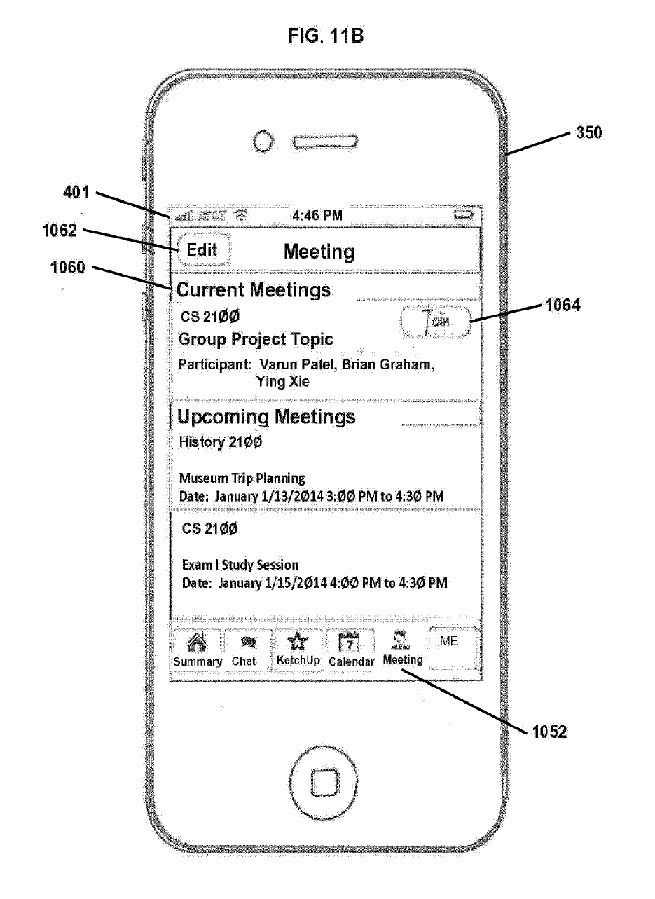

Other GUIs and menus provide a more general, non-group-specific interface to the enterprise mobile data system server. For example, FIG. 10A shows a GUI 401 displayed on an example mobile computing device 350 showing a list of user individual contacts 1011-1014 who have sent the user a new, unread message. This list is shown by selecting the “Chat” button 1020 at the bottom of the GUI. In various embodiments, these contacts may be listed on the screen in the order of the receipt time of the most recent message, or in the order of the contact's names, or in one of these as specified by a users preference. If the number of new unread messages from a contact exceeds 1, the number of messages 1022 is shown beside the contact name, e.g., “Brian Graham” 1013. As shown in FIG. 10B, selecting any contact, e.g., “Brian Graham” 1013, allows the user to view historical discussions with this contact, and exchange new messages with this contact. Selecting the “Contacts” symbol 1024 of FIG. 10A provides the user with access to a complete list of all the users contacts (as shown in FIG. 10C). Selecting the “Add Contacts” symbol 1025 of FIG. 10A enables the user to add a new contact from the user pool of the unified enterprise mobile data system 300. Using FIG. 10C as a general example, the user may search for and select new contacts to message from the users individual pool of contacts or from the user pool of the unified enterprise mobile data system 300. A user may use a text search box 1026 to narrow the displayed list based upon text matching, e.g., by first and/or last name, and the search results may be displayed as a live result or only in response to the users selection of a search icon 1028. The user may begin a new messaging session with a selected contact by clicking the plus icon 1030 within the display.

FIG. 10D shows a GUI 401 displayed on an example mobile computing device 350 showing an individual contact interface for an individual contact, in this example the user named “Brian Graham” 1013. The contact's user name is displayed at text box 1031, followed by the contact's email address at 1032. If the contact has posted a profile image, and both the user and the contact's permissions allow it, the profile image will be displayed at 1033. Other user information such as the contact's phone number, a user-selected ringtone for calls received from the contact, etc. may be displayed and, where appropriate, user-customized as well. The user may compose a text message or voice message to the contact by selecting the “Chat” button 1036, or compose an email to the contact by selecting the “send email” button 1038. Selecting either button opens an appropriate message composition interface.

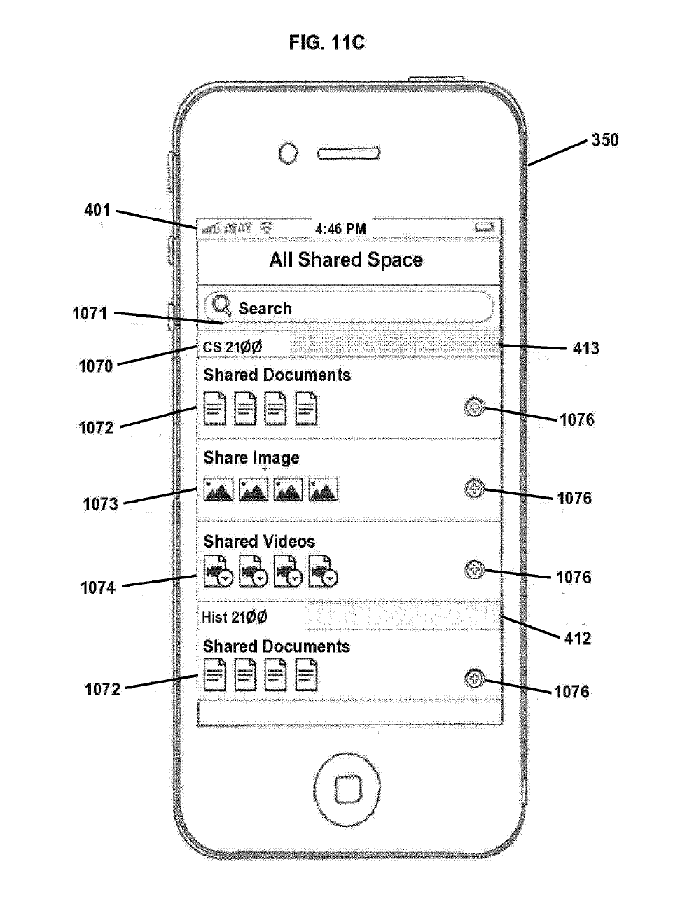

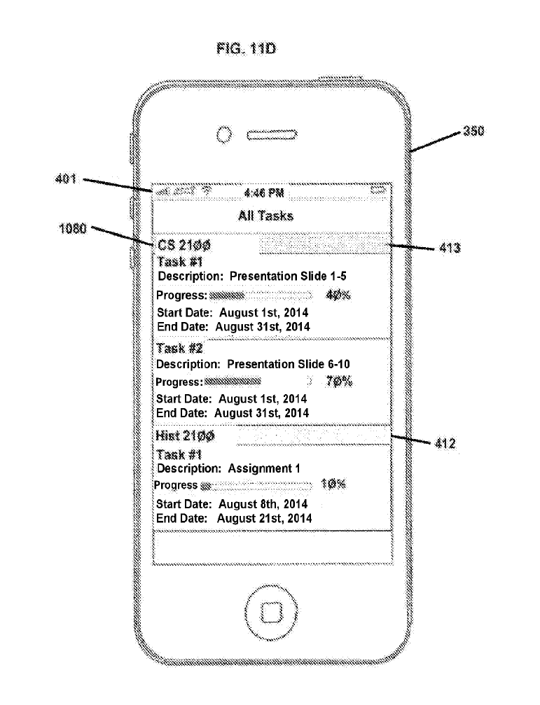

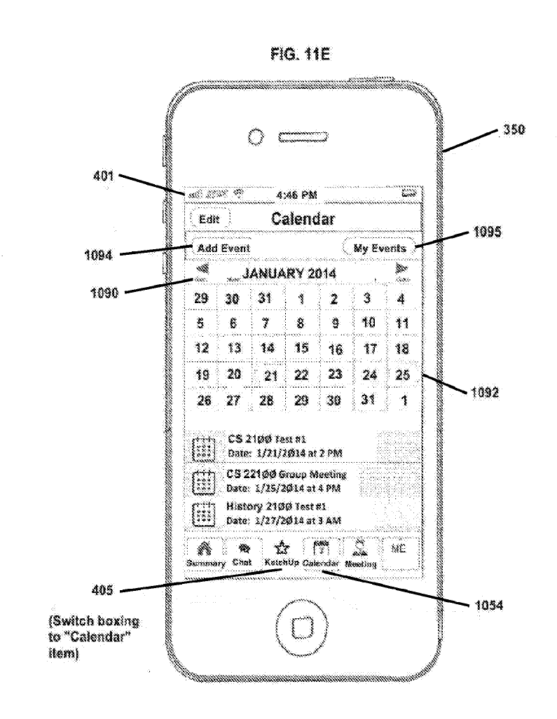

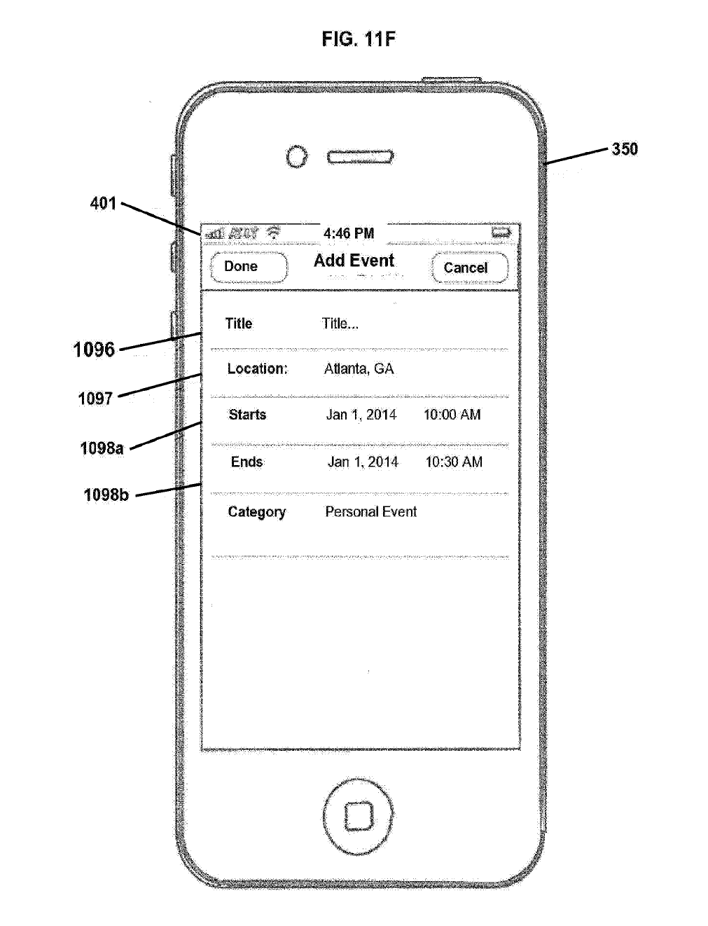

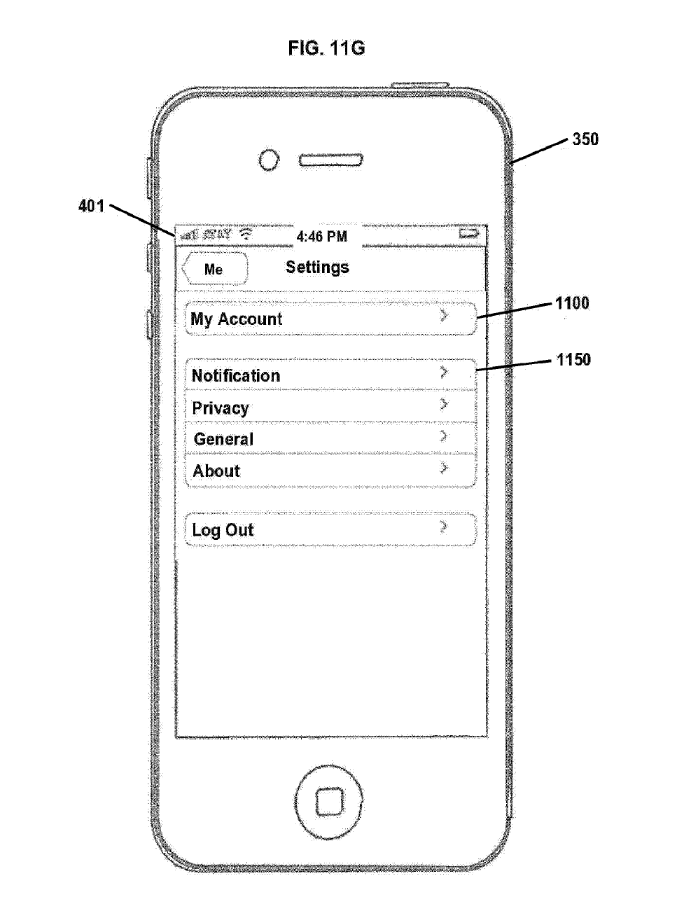

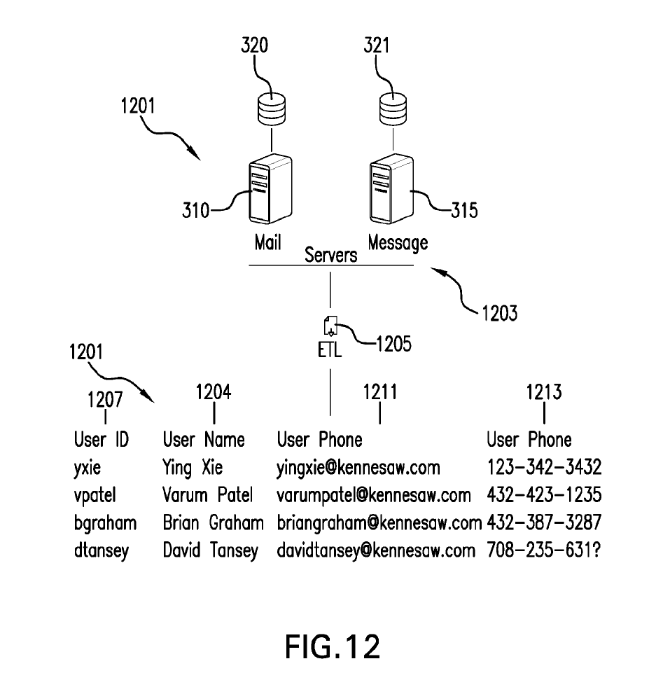

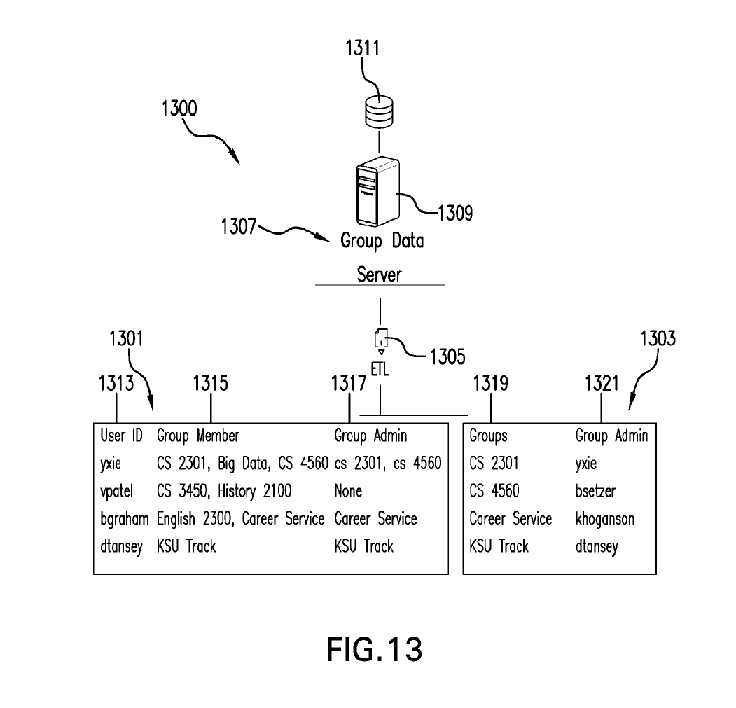

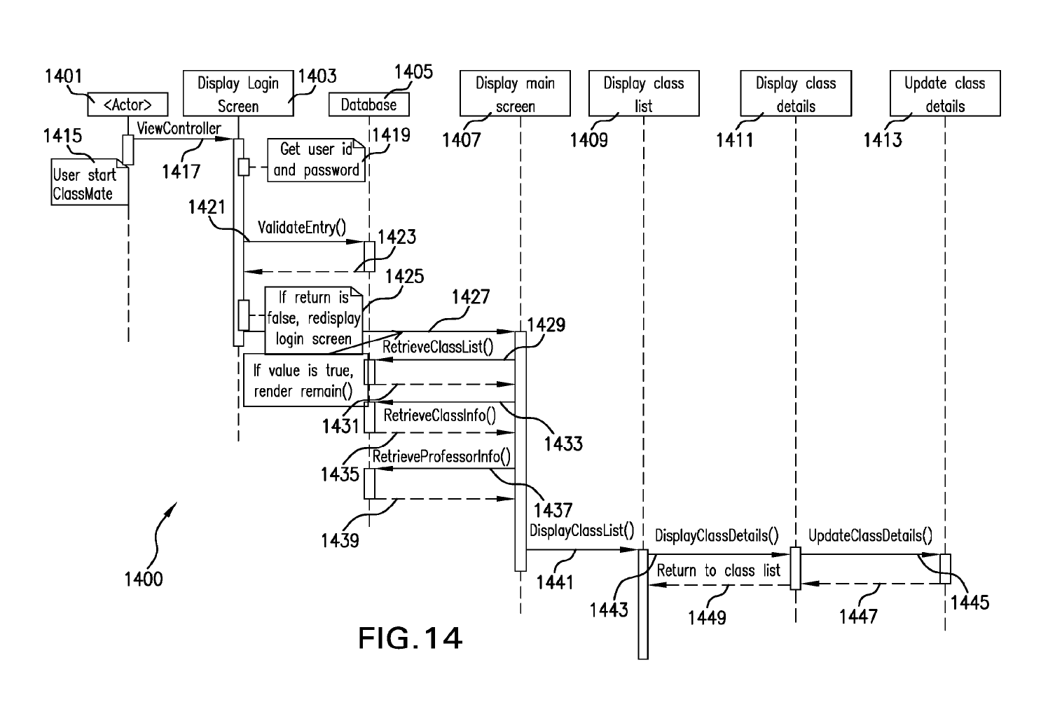

Referring to FIG. 11A, selecting the “Me” button 1040 at the bottom of the GUI 401 shows a menu to non-group-specific displays of the user's meetings 1042, shared spaces 1044, tasks 1046, and calendar 1048, as well as application settings and profile 1050. Predetermined or selected ones of these menus may alternately be invoked by a pressing button positioned at the bottom of most GUI screens, such as the Meeting button 1052 and Calendar button 1054 shown in this figure. Selecting the “Meetings” item 1042, or the Meeting button 1052, displays a list of all meetings in which the user is a participant. FIG. 11B displays a GUI 401 with a list of scheduled meetings 1060 including both current and upcoming meetings. However, in the non-group-specific display, the list entries additionally indicate how the user is associated with the meeting, i.e., which group and/or subgroup has created the meeting. Like the group-specific meeting area shown in FIG. 9D, the user may edit the listed meetings 1060 by pressing the “Edit” button 1062 or join a currently scheduled meeting by pressing the “Join” button 1064. The “Edit” button again functions similarly to the “Edit” button 505 for groups, allowing a subscribing user to delete a meeting from the listed meetings 1060 by selecting an “X” delete button (not shown in these figures) adjacent to the meeting he or she seeks to delete, or may select a meeting to alter the details of the selected meeting.

Selecting the “Shared Space” Item 1044, or a corresponding button, displays a view of all shared spaces in groups or subgroups to which the user is subscribed. FIG. 11C displays a GUI 401 with a partial view of shared spaces for exemplary groups CS 2100, 413, and History 2100, 412. Similarly, in the non-group-specific display, the displayed spaces indicate how the user is associated with the space and displayed files, i.e., which to which group and/or subgroup each group of files belongs, with the user scrolling through a by-group categorized list of files 1070 and/or filtering the list of files 1070 using a search box 1071. Like the group-specific shared space area shown in FIG. 9I, new documents 1072, images 1073, and/or videos 1074 may be added by selecting the plus icon 1076 besides the respective category or, where categorization is not used, within the generic document collection of the selected space. Documents are added to a selected shared space, e.g., the documents of History 2100, 412, by selecting the plus icon 1078 associated with that shared space.

Selecting the “Tasks” item 1046, or a corresponding button, displays a view of all tasks which the user has created or to which the user has been assigned. FIG. 11D displays a GUI 401 with a list of tasks 1080 associated with exemplary groups CS 2100, 413, and History 2100, 412. Again, in the non-group-specific display, the list of tasks 1080 or the list entries additionally indicate how the user is associated with the task, i.e., which group and/or subgroup has created the task. The list of tasks 1080 may be categorized by originating group or subgroup, as shown, or may be ordered according to some other property, such as beginning date, ending date, progress, etc.

Selecting the “Calendar” item 1048, or the Calendar button 1054, displays an aggregated calendar 1090 for the user. All meetings and events on the calendars from those groups with which the user is affiliated are shown in this aggregated calendar. The user may also add personal events to this calendar, with personal event alerts from this aggregated calendar also shown in the users summary screen (FIG. 6). FIG. 11E shows a GUI 401 displayed on example mobile computing device 350 with a graphical “aggregated calendar” 1090. Similar to a group calendar, days having scheduled events or meetings may include a highlight 1092, such as a circled date, a boldfaced date number, a colored date block, etc., and selecting any date on the calendar reveals a list of all group events occurring on that date. The display may also include a list 1093 of upcoming events and meetings so as to provide more detailed information such as titles, times, and immediate visibility of next-occurring events or meetings that fall on a subsequent calendar month. Again, in the non-group-specific display, the entries of events and meetings additionally indicate how the user is associated with the item, i.e., as a member of a group and/or subgroup or as a personal event. Different colored entries or backgrounds may be used to represent the different sources of the entries. Selecting the “Add Event” button 1094 allows the user to add a personal event with date, title, and description, to the user's calendar. Toggling a “My Events” button 1095 may filler the calendared and listed events so as to only display personal events, similar to the manner in which group events may be filtered through group selection via the mobile data system button 405 (e.g., the “Ketchup” button). FIG. 11F displays a GUI 401 for adding such a personal event, where the user specify a title 1096, location 1097, and start and end times 1098a and 1098b. The GUI 401 may display a non-editable title or data field indicating that the event is a “Personal Event” to provide context to the user.

Selecting the “Settings” item 1050 displays a flat or hierarchical menu of application settings for the user. The settings may include account and profile information 1100, such as a display name/nickname which the user may change in text box 1507, an email address that the user may change in text box 1509 and, optionally a profile image at 1511. Profile images may be uploaded and selected by a dialogue accessed by selecting the “images” button 1513. Any change to a user's profile or status is immediately propagated throughout the unified enterprise mobile data system 300, as the information is stored on the enterprise mobile data system server 305. A users profile and status are visible to the users contacts, and optionally to selected groups with which the user is associated. The settings may also include conventional application setting options 1150 such as notifications (to control how event and meeting notifications are displayed to the user through pop-up alerts, banners, and the like through operating system APIs); privacy settings (to display privacy policies and control access to data through inter-application messaging APIs); general settings (to set user preferences for fonts, colors, button options, application language, and the like); and software information.

In one example, the classes of the communications system may be described as in the following tables. Table 1 describes example global static methods of the system, which are generally directed towards providing a uniform display of the graphical user interface to users of the communications system.

TABLE 1
Class name: SystemGlobal
Brief description: Global static methods

| Attributes | Purpose | Design Characteristics |
|---|---|---|
| Methods | Purpose | Algorithmic Design |
| +(UIColor *) baseColor | | |
| +(UIFont *) baseFont | | |
| +(UIFont *) smallFont | | |
| +(UIFont *) exsmallFont | | |
| +(UIFont *) bigFont | | |
| +(UIFont *) titleFont | | |
| +(UIFont *) buttonFont | | |
| +(void)decorateNavitationbar | | |
| +(void)setDefaultButton:(UIButton*)b | Set up button in | Set up default button |
| title:(NSString *)title x:(int)x y:(int)y | default way | |
| width:(int)w height:(int)h | | |
| (NSString*)formattedDate | Print date | Convert date to medium date |
| | | style and short time style to display it |

Table 2 describes the attributes and methods of an example class used for the process encountered by users of the system when logging in to the system.

TABLE 2
Class name: LoginVC
Brief description: Has methods for the login process

| Attributes | Purpose | Design Characteristics |
|---|---|---|
| idTextField | Identify a unique | Initial value is blank, Text Field, |
| | user | min length is 6 |
| pwdTextField | Security | Initial value is blank, Text Field, |
| | Mechanism | min length is 8 |
| loginButton | Send a login | button |
| | information | |
| profile | Hold login User | Private SysternUser |
| | info | |
| Methods | Purpose | Algorithmic Design |
| (IBAction)loginClicked:(id)sender; | Validate entered | Read input from user into |
| | user ID and | attributes. |
| | Password to | Compare attributes to |
| | system | corresponding system database |
| | database 306 | 306 fields: |
| | | If a match is found, |
| | | Allow user access/display |
| | | main screen and save user |
| | | information in to profile |
| | | variable. |
| | | If a match is not found: |
| | | Ask user to re-enter user ID |
| | | and Password. |
| (void)alertStatus:(NSString *)msg :(NSString *)title; | Show alert | Display specific message in alert |
| | messages | window with title |
| (void)prepareForSegue:SystemTableVC | Push | Push SysternTableVC to display |
| | SystemTableVC | a list of group that user |
| | | subscribe. Set profile variable of |
| | | SysternTableVC with profile |

Table 3 describes the attributes and methods of an example class used for display to the user of the user's subscribed group lists.

TABLE 3
Class name: SystemTableVC
Brief description: display subscribed group list

| Attributes | Purpose | Design Characteristics |
|---|---|---|
| profile | Hold login user info | Public SystemUser |
| requiredGroupList | Space for a list of required | Private NSMutableArray |
| | groups | |
| electiveGroupList | Space for a list of elective | Private NSMutableArray |
| | groups | |
| Methods | Purpose | Algorithmic Design |
| (void)loadGroup | Load a list of group from | Private, retrieve a list of required |
| | the system database 306 | and elective group that user |
| | | subscribe with user id from |
| | | subscription database |
| (void)unSubscribe:(NSString*)gld | Delete group from the | Private, delete group from |
| | system database 306 | subscription database with user |
| | | id and group id |
| void)pushCreateGroupController:(id) | Push CreateGroupVC | Push CreateGroupVC to create |
| sender | | new elective group. Set profile |
| | | variable of CreateGroupVC with |
| | | profile. |
| (void)pushSubscribeGroupController:(id) | Push SubscribeGroupVC | Push SubscribeGroupVC to |
| sender | | subscribe new elective group. |
| | | Set variables of |
| | | SubscribeGroupVC: |
| | | userid with profile.userId, |
| | | subscribeGroup with |
| | | electiveGroupList |
| (void)prepareForSegue:GroupVC | Push GroupVC | Push GroupVC to display group |
| | | submenu. |
| | | Set variables of GroupVC: |
| | | profile with profile, |
| | | group with selected group in |
| | | table view |

Table 4 describes the attributes and methods of an example class used for creation of a new group in the system database 306.

TABLE 4
Class name: CreateGroupVC
Brief description: create new group and save it in system database 306

| Attributes | Purpose | Design Characteristics |
|---|---|---|
| groupNameTextField | Get a new group name | Public textfield |
| groupPWDTextField | Get a group password | Public textfield |
| pwd SWitch | Decide to have password | Public switch button |
| | or not | |
| Profile( or only user id? ) | Hold login user info | Public SystemUser |
| Invitee | Hold invitee users | Private NSMutableArray |
| needPWD | Check for need of PWD | Private BOOL |
| Methods | Purpose | Algorithmic Design |
| (void)sendInvitee:(NSMutableArray*) | Save invitee users into | Protocol method. |
| inviteeList | array | Save selected users in |
| | | SystemUserListTableVC to invite |
| | | to a new group into invitee array. |
| (void)postNewgroup | Send new group | Create new group with input and |
| | information to system | profile.userId. |
| | database 306 | Send it to database to save it. |
| (void)prepareForSegue: | Push | Push SystemUserListTableVC to |
| SystemUserListTableVC | SystemUserListTableVC | select invitee for a new group. |
| | | Set variables of |
| | | SystemUserListTableVC: |
| | | profile with profile, |
| | | listType with “all”. |

Table 5 describes the attributes and methods of an example class used to provide search functionality to the user, allowing the user to locate groups that the user has not joined.

TABLE 5
Class name: SubscribeGroupVC
Brief description: provide search functionality for unsubscribed groups and subscribe them

| Attributes | Purpose | Design Characteristics |
|---|---|---|
| subscribeGroup | Decide to have password | Public NSArray |
| | or not | |
| userId | Hold user id | Public NSString |
| groupList | Hold all group list | Private NSArray |
| refinedGroupList | Hold only elective(?), | Private NSMutableArray |
| | unsubscribed group list | |
| searchResults | Hold results of search | Private NSArray |
| selectedGroup | Get information of selected | Private SystemGroup |
| | group | |
| Methods | Purpose | Algorithmic Design |
| (void)alertStatus:(NSString *)msg | Show alert messages | Display specific message in alert |
| :(NSString *)title :(int)tag; | | window with title and get a |
| | | password for a group. |
| (void)loadGroup | Load all groups | Retrieve all groups from |
| | | database into groupList and |
| | | refinedGroupList. |
| (void)deleteSubscribedGroup | Delete already subscribed | Delete already subscribed |
| | groups from grouplist | group, subscribeGroup from |
| | | refinedGroupList. |
| (void)searchDisplayController:(UISearch | register a cell reuse | Search method |
| Controller*)controller | identifier for the search | |
| didLoadSearchResultsTableView: | results table view | |
| (UITableView *)tableView | | |
| (BOOL)searchDisplayController: | Perform search | Search method |
| (UISearchController *)controller | | |
| shouldReloadTableForSearchString: | | |
| (NSString *)searchString | | |
| void)postSubscription:(NSString*)gld{ | Send new subscription to | send new subscription to |
| | system database 306 | database with userid. |

Table 6 describes the describes the attributes and methods of an example class used to display user lists to a user of the communications system.

TABLE 6
Class name: SystemUserTableVC
Brief description: display all users or contact list and provide search functionality

| Attributes | Purpose | Design Characteristics |
|---|---|---|
| listType | Distinguish type of user | Public NSString |
| | list. All or contacts | |
| id<sendInviteeProtocol> delegate; | Send selected users | Public delegate |
| userListSearchBar | Display search bar | Public search bar |
| Profile(or only user d?) | Hold login user info | Public SystemUser |
| userList | Hold all user | Private NSArray |
| searchResults | Hold search results | Private NSArray |
| invitee | Hold selected users | Private NSMutableArray |
| Methods | Purpose | Algorithmic Design |
| (void)searchDisplayController: (UISearch | register a cell reuse | Search method |
| Controller*)controller | identifier for the search | |
| didLoadSearchResultsTableView: (UITable | results table view | |
| View*)tableView | | |
| (BOOL)searchDisplayController: (UISearch | Perform search | Search method |
| Controller *)controller | | |
| shouldReloadTableForSearchString: (NS | | |
| String *)searchString | | |
| (void)doneBTNClick | Send selected users to the | Send invitee(selected users) to |
| | CreateGroupVC | the CreateGroupVC using |
| | | delegate |
| (void)loadAllUser | Retrieve all users from | If listType is equal to “all”, |
| | system database 306 | Retrieve all users from database |
| | | and save them in userList |
| (void)loadContactList | Retrieve users in contact | If listType is equal to “contacts”, |
| | from system database 306 | Retrieve users in contact from |
| | | database with profile.userId and |
| | | save them in userList |
| (void)prepareForSegue: UserInfoVC | Push UserInfoVC | Push UserInfoVC to display |
| | | selected user's info. |
| | | Set variables of UserInfoVC: |
| | | profile with profile, |
| | | user with selected user in |
| | | tableView |

Table 7 describes the attributes and methods of an example class used for displaying various group-specific submenus and views to a user of the communications system.

TABLE 7
Class name: GroupVC
Brief description: display submenu of each group

| Attributes | Purpose | Design Characteristics |
|---|---|---|
| profile | Hold login user info | Public SystemUser |
| group | Hold group info | Public SystemGroup |
| admin | Hold administrator info | Private SystemUser |
| profileSubRights | Hold group rights of login | Private SystemSubscription |
| | user | |
| chatFrameView | Display chat view | Private ChatFrameVC |
| subgroupView | Display subgroup view | Private SubgroupTableVC |
| sharedspaceView | Display sharedspace view | Private SharedSpaceVC |
| tasksView | Display tasks view | Private TasksVC |
| meetingView | Display meeting view | Private MeetingTableVC |
| calendarView | Display calendar view | Private CarlendarVC |
| Methods | Purpose | Algorithmic Design |
| (void) createMenuBTN | Display submenu | Create buttons to display group |
| | | submenu |
| (void)setTopButton: (UIButton*)b | Decide location and | Set up location and decoration of |
| title: (NSString *)title x: (int)x | decoration of a submenu | a button |
| y: (int)y width: (int)w height: (int)h | button | |
| (void)showGroupInfo: (id)sender | Perform prepareForSegue | When click “info” button, Perform |
| | method | prepareForSegue method to |
| | | push GroupInfoTableVC |
| (void)displayContentController: | Display submenu VC | Display submenu VC using |
| (UIViewController*) content | | addChildViewController |
| (void)hideContentController: | Hide submenu VC | Hide submenu VC using |
| (UIViewController*) content | | removeFromSuperview |
| (void)retreiveChat | Display chat view of | Display chatFrameView in self |
| | submenu | view |
| (void)retreiveSubgroup | Display subgroup view of | Display subgroupView in self |
| | submenu | view |
| (void)retreiveSharedspace | Display sharedspace view | Display sharedspaceView in self |
| | of submenu | view |
| (void)retreiveTask | Display task view of | Display taskView in self view |
| | submenu | |
| (void)retreiveMeeting | Display meeting view of | Display meetingView in self view |
| | submenu | |
| (void)retreiveCarlendar | Display calendar view of | Display calendarView in self |
| | submenu | view |
| (void)loadAdmin | Retrieve creator info of | Retrieve creator info from |
| | group from system | database using group.creatorId |
| | database 306 | |
| (void)getSubscriptionInfo | Retrieve multiple rights of | Retrieve list of rights of BOOL |
| | login user about selected | type of login user from database |
| | group from system | about selected group using |
| | database 306 | profile.userId and group.groupId |
| (void)prepareForSegue: | Push GroupInfoTableVC | Push GroupInfoTableVC to |
| GroupInfoTableVC | | display group submenu. |
| | | Set variabsse of |
| | | GroupInfoTableVC: |
| | | profile with profile, |
| | | group with group, |
| | | admin with admin, |
| | | designationRight with |
| | | profileSubRights.designation |
| | | Right. |

Table 8 describes the attributes and methods of an example class used for displaying information about a particular group to a user of the communications system.

TABLE 8
Class name: GroupInfoVC
Brief description: display info of selected group

| Attributes | Purpose | Design Characteristics |
|---|---|---|
| profile | Hold login user info | Public SystemUser |
| group | Hold group info | Public SystemGroup |
| admin | Hold administrator info | Public SystemUser |
| designationRight | Hold designation right | Public BOOL |
| | of login user | |
| Event | Display group events | Private NSArray |
| participants | Display group | Private NSArray |
| | participants | |
| Methods | Purpose | Algorithmic Design |
| (void) | Retrieve participants | Retrieve list of participants of |
| loadParticipants | list of selected group | selected group from database |
| | from system database | using group.groupId and |
| | 306 | @“requestType”: |
| | | @“participants” |
| (void) | Push UserInfoVC | Push UserInfoVC to display |
| prepareForSegue: | | selected user's info. |
| UserInfoVC | | Set variable of UserInfoVC: |
| | | Profile with profile, |
| | | user with selected user in |
| | | tableView |

Table 9 describes the attributes and methods of an example class used for displaying to a user of the communications system information about another selected user of the communications system.

TABLE 9
Class name: UserInfoVC
Brief description: display info of selected user

| Attributes | Purpose | Design Characteristics |
|---|---|---|
| profile | Hold login user info | Public SystemUser |
| user | Hold selected user | Public SystemUser |
| | info | |
| name | Display name of | Public UILabel |
| | selected user | |
| email | Display email of | Public UILabel |
| | selected user | |
| mobile | Display mobile of | Public UILabel |
| | selected user | |
| rington | Display ringtone of | Public UILabel |
| | selected user | |
| Methods | Purpose | Algorithmic Design |
| (IBAction)btnQR: | Display QR code | |
| (id)sender | | |
| (IBAction) | Start chat with | Initialize ChatFrameVC and |
| btnStartChat: | selected user | push it. |
| (id)sender | | Set variables of ChatFrameVC: |
| | | profile with profile, |
| | | canWriteMessage with YES, |
| | | chatType with 1 |
| | | (personal chat), |
| | | (? Need userinchatId and |
| | | chatroom id) |
| (IBAction) | Add selected user in | |
| btnAddToFav: | contacts | |
| (id)sender | | |

Table 10 describes the attributes and methods of an example class used for displaying to a user of the communications system, a list of personal chat sessions between that user and other users of the communications system.

TABLE 10
Class name: ChatTableVC
Brief description: display list of personal chat

| Attributes | Purpose | Design Characteristics |
|---|---|---|
| profile | Hold login user | Public SystemUser |
| | info | |
| chatList | Hold list of | Private NSArray |
| | personal chat | |
| Methods | Purpose | Algorithmic Design |
| (void)loadChat | Retrieve personal | Retrieve personal chat list from |
| | chat list | database using profile.userId |
| (void) | Push | Push ChatFrameVC to display |
| prepareForSegue: | ChatFrameVC | chat view. |
| ChatFrameVC | | Set variables of ChatFrameVC: |
| | | profile with profile, |
| | | canWriteMessage with YES, |
| | | chatType with 1 |
| | | (personal chat), |
| | | chatId with selected chat.chatId, |
| | | userInChatId with selected |
| | | chat.userInChatId. |
| (void) | Push | Push SystemUserListTableVC to |
| prepareForSegue: | SystemUser | display contacts. |
| SystemUser | ListTableVC | Set prof variable of |
| ListTableVC | to display contact | SystemUserListTableVC: |
| | | profile with profile, |
| | | listType with “contacts” |

Table 11 describes the attributes and methods of an example class used for displaying to a user of the communications system, a frame for viewing a selected chat session between that user and other users of the communications system, and for accepting text entered by the user to send in the chat session, provided the user has appropriate permissions regarding the chat session.

TABLE 11
Class name: ChatFrameVC
Brief description: form frame for chat view <UITextFieldDelegate, sendHeightProtocol>

| Attributes | Purpose | Design Characteristics |
|---|---|---|
| profile | Hold login user info | Public SystemUser |
| canWriteMessage | Decide whether user can write | Public BOOL. |
| | a message in chat | In case of informative group |
| | | chat, if user doesn't have |
| | | designation right, set it to NO. |
| | | Otherwise set it to YES |
| chatId | Hold chatroom id of personal | Public NSString |
| | chat | |
| chatType | Distinguish type of chat | Public |
| | | typedef enum { |
| | | groupChat, |
| | | personalChat, |
| | | meetingChat |
| | | }chatType; |
| userInChatId | Hold another user id in chat | Public NSString |
| messageTextField | Type a chat message | public UITextField |
| chatView | Display list of chat message | Private ChatViewController |
| | in screen | |
| scrollView | Make chat view scroll view | Private UIScrollView |
| chatViewHeight | send actual chat screen | Private NSInteger |
| | height from chat view to | |
| | chatFrame View | |
| Methods | Purpose | Algorithmic Design |
| (void)displayChatView | Display chat view in | Initialize chatView. |
| | chatFrameVC | Set variables of chatView: |
| | | Profile with profile, |
| | | chatType with chatType, |
| | | chatId with chatId, |
| | | userInChat with userInChat. |
| | | Set delegate of chatView to |
| | | chatFrameVC to send a height |
| | | of chatView. |
| (void)addInfoToMeetingChat | Display info of meeting in | Put UILabel “current meeintg” at |
| | case of meeting chat | the top |
| (void) displayContentController: | Set scrollview and | Initialize scrollview and add it to |
| (UIViewController*) content | chatview, then display them | the subview of chatFrameVC. |
| | | Then add chatView to the |
| | | subview of scrollview. |
| (void)postMesage: (NSString*)message | Upload a chat message to | Create a message and send it to |
| | system database 306 | database with profile.userId and |
| | | message content and chatId. Set |
| | | reguestType according to chat |
| | | type, “personal” or “group” or |
| | | “meeting” |
| (void)sendHeight: (NSInteger)height | Send height of chatView | sendHeightProtocol method. |
| | screen to the chatFrameVC | |
| (void)viewDidLayoutSubviews | Scroll down to the bottom | Set CGPoint bottomOffset to |
| | of the chat view | scroll to the bottom in the chat |
| | | view screen |
| (void)prepareForSegue: | Push | Push SystemUserListTableVC to |
| SystemUserListTableVC | SystemUserListTableVC | display contacts. |
| | to display contact | Set variables of |
| | | SystemUserListTableVC: |
| | | Profile with profile, |
| | | listType with “contacts” |

Table 12 describes the attributes and methods of an example class used for displaying to a user of the communications system, a selected chat sessions between that user and other users of the communications system within the frame described in Table 11, and allowing the user to send and receive text in the chat system.

TABLE 12
Class name: ChatVC
Brief description: display chat messages

| Attributes | Purpose | Design Characteristics |
|---|---|---|
| profile | Hold login user info | Public SystemUser |
| chatId | Hold chatroom id of | Public NSString |
| | personal chat | |
| chatType | Distinguish type of chat | Public |
| | | typedef enum { |
| | | groupChat, |
| | | personalChat, |
| | | meetingChat |
| | | }chatType; |
| userInChatId | Hold another user id in | Public NSString |
| | chat | |
| delegate | Send chat view height to | Public id<sendHeightProtocol> |
| | chatFrameVC | |
| messageList | Hold entire chat messages | Private NSArray |
| sortedMessageList | Hold sorted messages in | Private NSArray |
| | ascending order of time | |
| extraMessageHeight | Extra message height for | Private NSInteger |
| | multiple lines | |
| contentHeight | Single message height | Private NSInteger |
| Methods | Purpose | Algorithmic Design |
| (void)loadMessage | Retrieve messages from | Retrieve messages from |
| | system database 306 | database using chatId and |
| | | requestType(chatType, |
| | | group = 0, personal = 1, |
| | | meeting = 2) |
| | | Call sortMessage and |
| | | displayChat method. |
| | | Send contentHeight of chat view |
| | | height to ChatFrameVC using |
| | | delegate. |
| (void)sortMessageList | Sort messages by | Compare messages and sort by |
| | ascending order of created | ascending order of created time |
| | time | of it and save in |
| | | sortedMessageList |
| (void)displayChat | Set up y coordinate of | Set up y coordinate of each |
| | each message | message and call |
| | | displayMessage method. |
| (void)displayMessage: | Display each message | Display each message with |
| (SystemMessage*) message | | name label and time label. |
| height: (NSInteger)y | | |
| (void)setupLable: (UILabel*) label | Decorate label text | Decorate label text |
| font: (UIFont*) font nol: (NSInteger) | | |
| nol bgeolor: (UIColor*) bgcolor | | |
| tcolor: (UIColor*) tcolor | | |
| (void)setPaddingToLabel: (NSString*) | Set padding to label | Set padding to label |
| title label: (UILabel*)label | | |
| (void)setDynamicHeight: (UILabel*) | Set extra height for | Set extra height for message |
| label | message occupying | occupying multiple line |
| | multiple line | |

Table 13 describes the attributes and methods of an example class used for maintaining the user information of an individual user of the communications system.

TABLE 13
Class name: SystemUser
Brief description: A generic type of user

| Attributes | Purpose | Design Characteristics |
|---|---|---|
| userId | Identify a unique | Public NSString |
| | user | |
| loginId | Identify a unique | Public NSString |
| | user | |
| pwd | Security | Public NSString |
| | Mechanism | |
| firstName | Users first name | Public NSString |
| lastName | Users last name | Public NSString |
| email | Keep Contact | Public NSString |
| | information | |
| mobile | Keep Contact | Public NSString |
| | information | |
| Methods | Purpose | Algorithmic Design |
| +(RKObjectMapping*) | Map attributes | Map attributes of a user |
| mapping | from system | with ones from database |
| | database 306 | using Restkit mapping |
| (NSString*) | Getfull name of | Combine first name and last |
| getFullname | user | name and return it |
| (void)setupKeychain | | |
| (void)retreiveKeychain | | |

Table 14 describes the attributes and methods of an example class used for maintaining the group information of a particular group within the communications system.

TABLE 14
Class name: SystemGroup
Brief description: A generic type of group

| Attributes | Purpose | Design Characteristics |
|---|---|---|
| GroupId | Identify a unique group | Public NSString |
| groupName | Display name of a group | Public NSString |
| groupType | Distinguish type of | Public NSString |
| | group, | |
| | ‘R’ for required group, | |
| | ‘E’ for elective group, | |
| | ‘RS’ tor required | |
| | subgroup, | |
| | ‘ES’ for elective | |
| | subgroup | |
| createdDate | Get created date for a | Public NSDate |
| | group | |
| creator | Get creator of a group | Public NSString |
| upperGroup | Get upper group info | Public NSString |
| needPWD | Decide need password | Public NSInteger |
| | to access to group | |
| groupPWD | Group security | Public NSString |
| | mechanism | |
| isInformative | Decide Group type is | Public BOOL |
| | informative | |
| isActive | Decide group is active | Public BOOL |
| Methods | Purpose | Algorithmic Design |
| +(RKObjectMapping*) | Map attributes from | Map attributes of a |
| mapping | system database 306 | group with ones from |
| | | database using |
| | | Restkit mapping |
| (NSString*) | Print date | Convert date to |
| formattedDate | | medium date style |
| | | and short time style |
| | | to display it |

Table 15 describes the attributes and methods of an example class used for implementing a subscription of a user of the communications system to a particular group within the communications system.

TABLE 15
Class name: SystemSubscription
Brief description: A generic type of subscription to a group

| Attributes | Purpose | Design Characteristics |
|---|---|---|
| userId | Identify a unique user | Public NSString |
| groupId | Identify a unique group | Public NSString |
| designationRight | Group management | Public BOOL |
| | right | |
| subgroupRight | Right for creating | Public BOOL |
| | subgroup | |
| taskRight | Right for creating new | Public BOOL |
| | task | |
| sharedspaceRight | Right for creating new | Public BOOL |
| | shared space data | |
| meetingRight | Right for creating new | Public BOOL |
| | meeting | |
| eventRight | Right for creating new | Public BOOL |
| | event | |
| Methods | Purpose | Algorithmic Design |
| +(RKObjectMapping*) | Map attributes from | Map attributes of a |
| mapping | system database 306 | subscription with ones |
| | | from database using |
| | | Restkit mapping |

Table 16 describes the attributes and methods of an example class used for implementing participation by a user of the communications system in a specific chat session.

TABLE 16
Class name: SystemChat
Brief description: A generic type of chat

| Attributes | Purpose | Design Characteristics |
|---|---|---|
| chatId; | Identify a unique chat | Public NSString |
| userInChatId | Identify a participating | Public NSString |
| | user in a chat | |
| userInChatFirstname | Users first name | Public NSString |
| userInChatLastname | Users last name | Public NSString |
| Methods | Purpose | Algorithmic Design |
| +(RKObjectMapping*) | Map attributes from | Map attributes of a chat |
| mapping | system database 306 | with ones from database |
| | | using Restkit mapping |

Table 17 describes the attributes and methods of an example class used for maintaining the identification and substance of a particular chat message within the communications system.

TABLE 17
Class name: SystemMessage
Brief description: A generic type of message in chat

| Attributes | Purpose | Design Characteristics |
|---|---|---|
| messageId | Identify a unique | Public NSString |
| | message | |
| messageBody | A message content | Public NSString |
| userIdFrom | A creator of a message | Public NSString |
| userFromFname | A first name of a | Public NSString |
| | creator of a message | |
| userFromLname | A last name of a | Public NSString |
| | creator of a message | |
| createdTime | Created time of a | Public NSDate |
| | message | |
| chatId | ChatId of a message | Public NSString |
| Methods | Purpose | Algorithmic Design |
| +(RKObjectMapping*) | Map attributes from | Map attributes of a |
| mapping | system database 306 | message with ones |
| | | from database using |
| | | Restkit mapping |
| (NSString*) | Get full name of a | Combine first name and |
| getFullname | user | last name and return it |
| (NSString*) | Print date | Convert date to medium |
| formattedDate | | date style and short time |
| | | style to display it |

Table 18 describes the attributes and methods of an example class used for maintaining the identification and substance of a particular meeting message for a meeting occurring within the communications system.

TABLE 18
Class name: SystemMeeting
Brief description: A generic type of message in meeting

| Attributes | Purpose | Design Characteristics |
|---|---|---|
| meetingId | Identify a unique | Public NSString |
| | meeting | |
| meetingName | A meeting name | Public NSString |
| creator | A creator of a meeting | Public NSString |
| category | A first name of a | Public NSString |
| | creator of a message | |
| start | Start time of a meeting | Public NSDate |
| end | End time of a meeting | Public NSDate |
| createdDate | Created time of a | Public NSDate |
| | meeting | |
| Methods | Purpose | Algorithmic Design |
| +(RKObjectMapping*) | Map attributes from | Map attributes of a |
| mapping | system database 306 | meeting with ones |
| | | from database using |
| | | Restkit mapping |
| (NSString*) | Print date | Convert date to |
| formattedDate | | medium date style and |
| | | short time style to |
| | | display it |

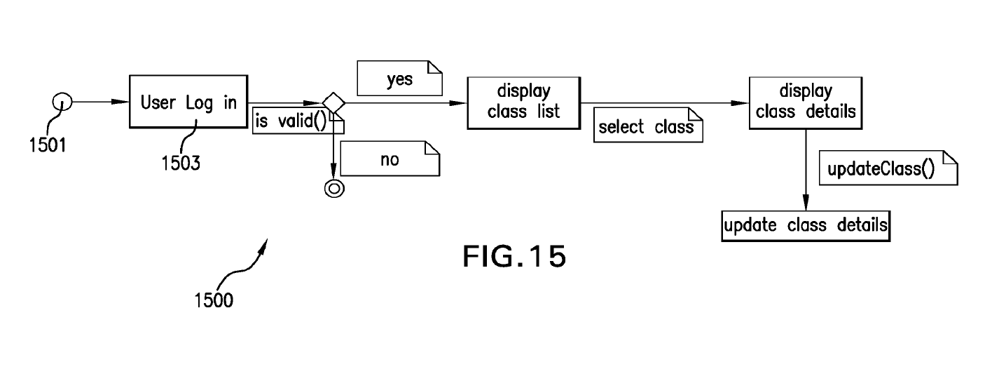

When setting up the enterprise mobile data system 300, system administrators can initialize user information for the system by importing the user information from existing database systems of the enterprise. Referring to FIG. 12, a diagram 1200 illustrating an example process of initializing an example user table 1201 of system database 306 is shown. The user records populating the example user table 1201 may be imported from existing enterprise database systems 1203, such as the database 320 of email server 310 and/or the database 321 of instant messaging server 315 through an implementation of an Extract. Transform, and Load (ETL) process 1205. Information about a user, such as User ID 1207, User Name 1209, User Email Address 1211, and User Phone Number 1213, are commonly available from existing enterprise database systems 1203, and may be sufficient to pre-populate the example user table 1201 of system database 306.

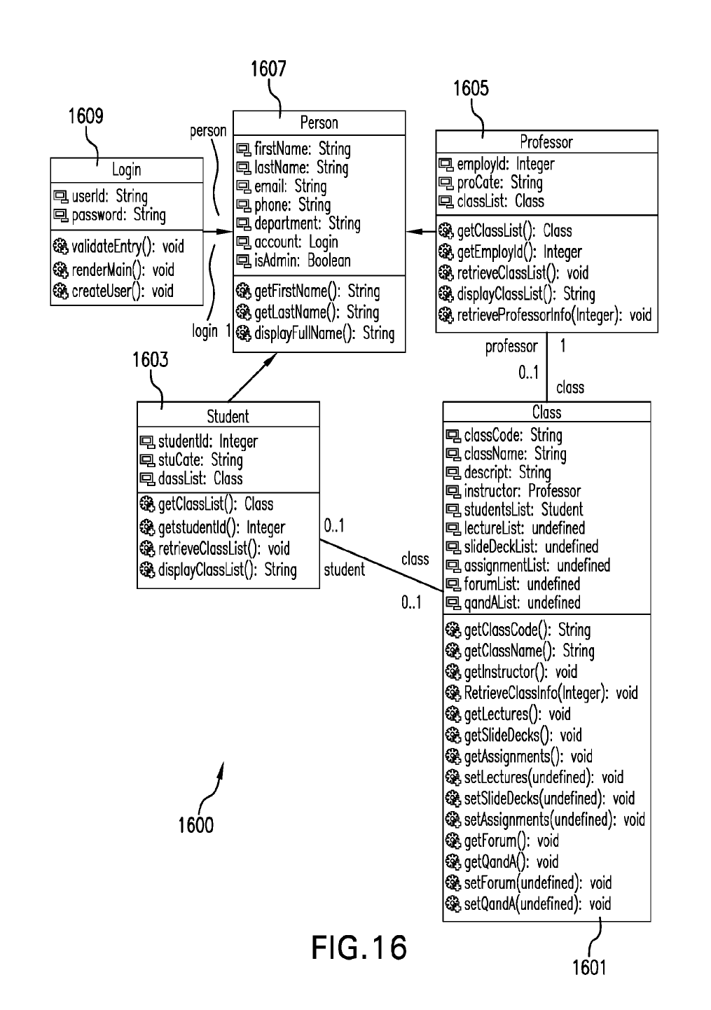

When setting up the enterprise mobile data system 300, the business may also, for example, Initialize a set of groups for the enterprise mobile data system by importing the user information from existing database systems of the enterprise. Referring to FIG. 13, a diagram 1300 illustrating an example process of initializing group membership information in an example user table 1301 of system database 306, and of initializing group administration information in an example group table 1303 of system database 306. The records to populate both tables 1301 and 1303 can be imported by an implementation of an ETL process 1305. This importation may be from existing enterprise database systems 1307, which may include a server 1309 and database 1311 such as the database 320 of email server 310 and/or the database 321 of instant messaging server 315, or other appropriate enterprise human resources data systems that may be indicative of a user's membership in a group. Information indicating a user's membership in a group, including User ID 1313, an array of User's Group Memberships 1315, and an array of administrative statuses 1317, may be sufficient to pre-populate the example user table 1301 of system database 306. It may be desirable to include the User ID, 1207, 1313, User Name 1209, User Email Address 1211, User Phone Number 1213, User's Group Memberships 1315, and User's Administrative Statuses 1317 in a single table. Information indicating the existence of a group, such as Group Name 1319 and Administrator User ID 1321 of that group may be sufficient to pre-populate example group table 1303 of system database 306.

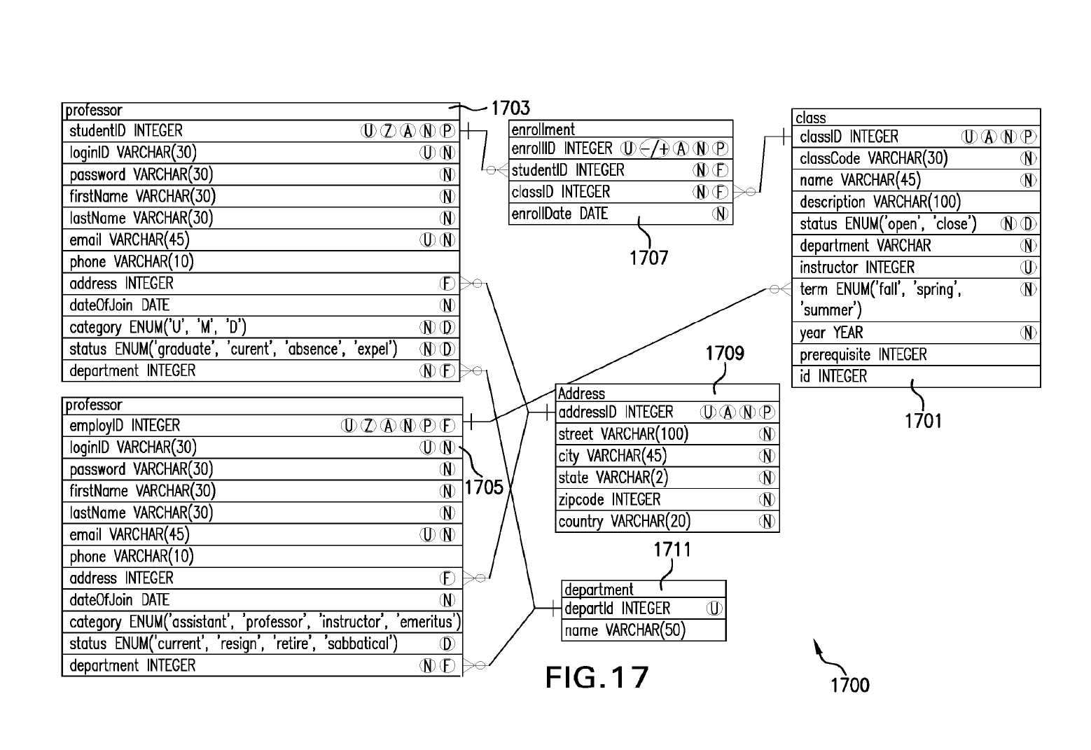

Referring to FIG. 14, a sequence diagram 1400 shows the interaction of the exemplary user 1401, the login screen 1403 presented to the user 1401, the underlying system database 1405, 306, the display functions main screen 1407, class list 1409, and class details 1411, and the update class details function, when the user acts to update information of an academic “class” group in an example system. Initially, at 1415, the user initiates its effort to update the details of the class. The user is presented, over view controller 1417, a password protected login screen 1403. The user 1401 enters 1419 its user ID and password at the login screen 1403. The user ID and password are validated 1421 against the system database 1405, and the Boolean validation result is returned 1423. If the validation is false, the login screen is redisplayed 1425. If the validation is true, the system proceeds 1427 to render the main screen 1407 of the program. This includes the functions for retrieving 1429 the class list from the database 1405 and returning it 1431 to the main screen 1407, retrieving 1433 the class information from the database 1405 and returning it 1435 to the main screen 1407, and retrieving 1437 the professor information from the database 1405 and returning it 1439 to the main screen. When the user 1401 elects to display the class list, the function for displaying the class list 1441 is called, and the class list is displayed 1409. When the user 1401 elects to display the details of a class, the function for displaying the class details 1443 is called, and the class details are displayed 1411. When the user 1401 elects to update the details of a class, the function for updating the class details 1445 is called, and the update class details interface is displayed 1413. Completion of updating the class details, either by updating or canceling, returns the display to display of class details 1411. Closing this view returns the display to display of class list 1409.

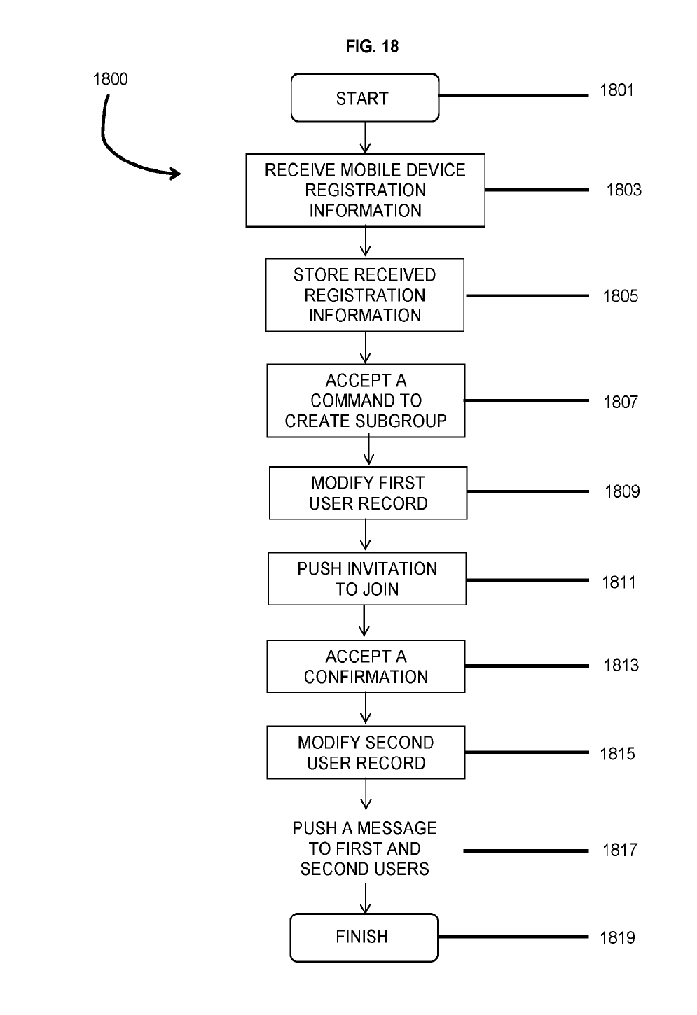

Referring to FIG. 15, a state machine diagram for the user's exemplary possible actions when the user may act to update information of an academic “class” group in an example system. The state of the system begins at start state 1501, and continues to user log in state 1503, where the user enters login credentials, such as user ID and password, which move the system to decision block 1505. At decision block 1505, where the system determines whether the presented credentials are valid. If the credentials are not valid, the system enters end state 1507, from which the system may be restarted at start state 1501. If the credentials are valid, the system enters display class list state 1509. If the user selects a class 1511, the system enters display class details state 1513. If the user chooses to update the selected class 1515, the system enters update class details state 1517. At any of states 1509, 1513, and 1517, the user may also choose to log out and go to end state 1507. At either of states 1513 or 1517, the user may also choose to return to the previous state.

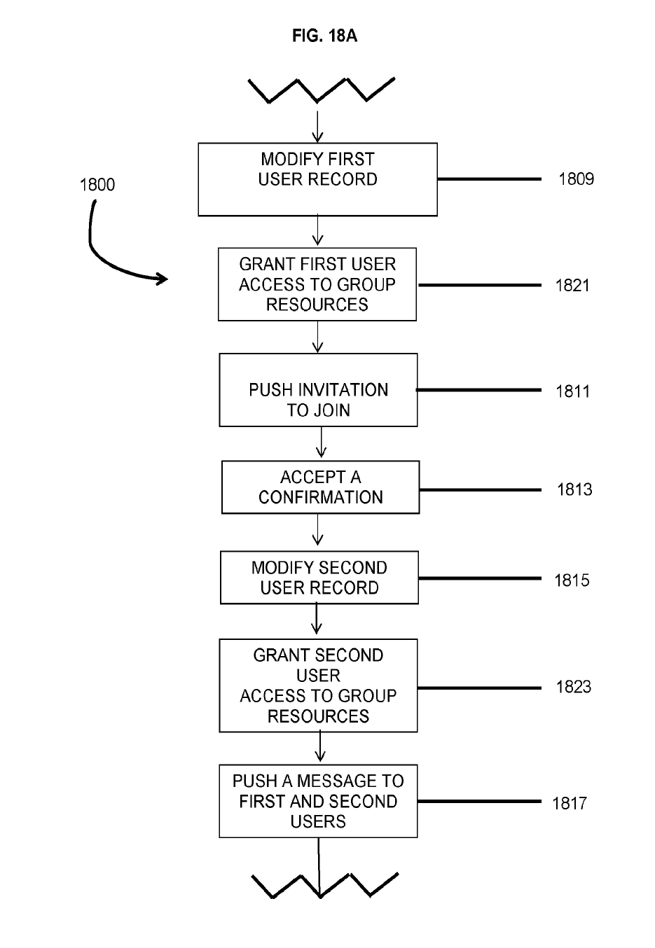

In a simple example demonstrating how groups in the enterprise mobile data system relate to real world organization, a class 1600 diagram showing the organization of an academic “class” group in an example system is presented in FIG. 16. The “Class” class 1601 has attributes classCode, className, description, instructor, studentsList, lectureList, slideDeckList, assignmentList, forum list, and qandAList; as well as respective methods for setting and getting the values of each of those attributes, as may be appropriate. The attributes describing the “Class” class 1601 act to describe the real world academic class that it represents. A “Class” class 1601 has a many to one relationship with the “Student” class 1603, which also tracks the real-life organization of the academic situation. Human students may have many classes, and academic classes may be made up of many students. The attributes describing the “Student” class 1603, studentID, stuCate(gory), and classList are the pieces of information in the system that describe the relationship of the student to its academic environment. Appropriate methods for retrieving these attributes are also incorporated in “Student” class 1603. The “Professor” class 1605, on the other hand, has a one to many relationship with the “Class” class 1601, as is appropriate to describe the real world situation. An academic class has but one professor, while a professor may teach many classes. The attributes describing the “Professor” class 1605, employID, proCate(gory), and classList are the pieces of information in the system that describe the relationship of the student to its academic environment. Appropriate methods for retrieving these attributes are also incorporated in “Professor” class 1605. As in the real world, both the “Student” class 1603 and the “Professor” class 1605 are subclasses of the “Person” class 1607. “Person” class 1607 contains further attributes that serve to additionally distinguish the individual person from other members of the class, including firstName, lastName, email, phone, department, account, and isAdmin(istrator of the group). Appropriate methods for retrieving these attributes are also incorporated in “Person” class 1607. Further, a “Login” class 1609 of credentials for a person has a one to one relationship with the “Person” class 1607. Appropriate attributes and methods for providing access to the system are included.

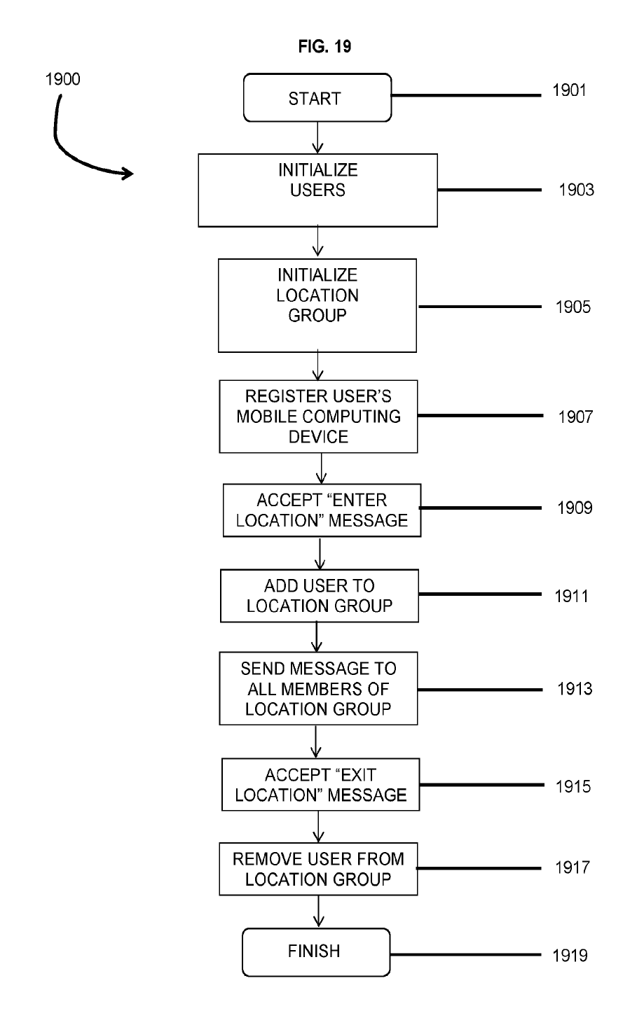

In another simple example demonstrating how groups in the enterprise mobile data system relate to the real world organization of the enterprise, FIG. 17 shows a simple exemplary database schema 1700. A Class table 1701 is shown, which includes columns for key classID, classCode, name, description, status, department, instructor, term, year, prerequisite, and id. A Student table 1703 is shown, which includes columns for key studentID, loginID, password, firstName, lastName, email, phone, address, dateOfJoin, category, status, and department. As a student is related to their class by enrollment, an Enrollment table 1707 manages the relationship between the Student table 1703 and the Class table 1701. Enrollment table 1707 includes columns for key enrollID, studentID, classID, and enrollDate, thereby describing the relationship between a student and their class. A Professor table 1705 is shown, which includes columns for key employID, loginID, password, firstName, lastName, email, phone, address, dateOfJoin, category, status, and department. The Professor table 1705 relates directly to the instructor column of the Class table, which would contain the Professor's employID, again indicating that a Professor has a direct relationship with their class. An Address table 1709 is shown, with columns for key addressID, street, city, state, zipcode, and country. A Department table 1711 is shown, with columns for key departmentID, and name. Both Professor table 1705 and Student table 1703 have a direct relationship from their address and department columns to these tables 1709 and 1711, respectively.

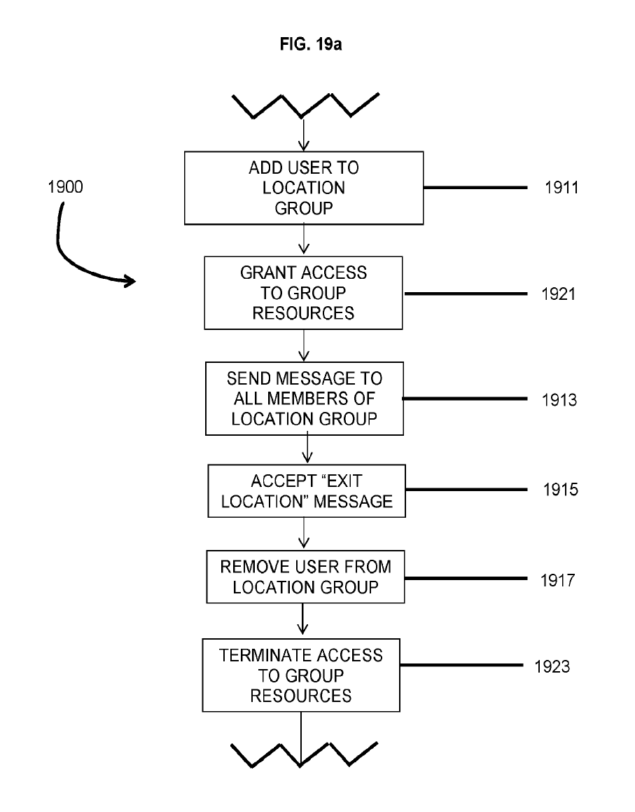

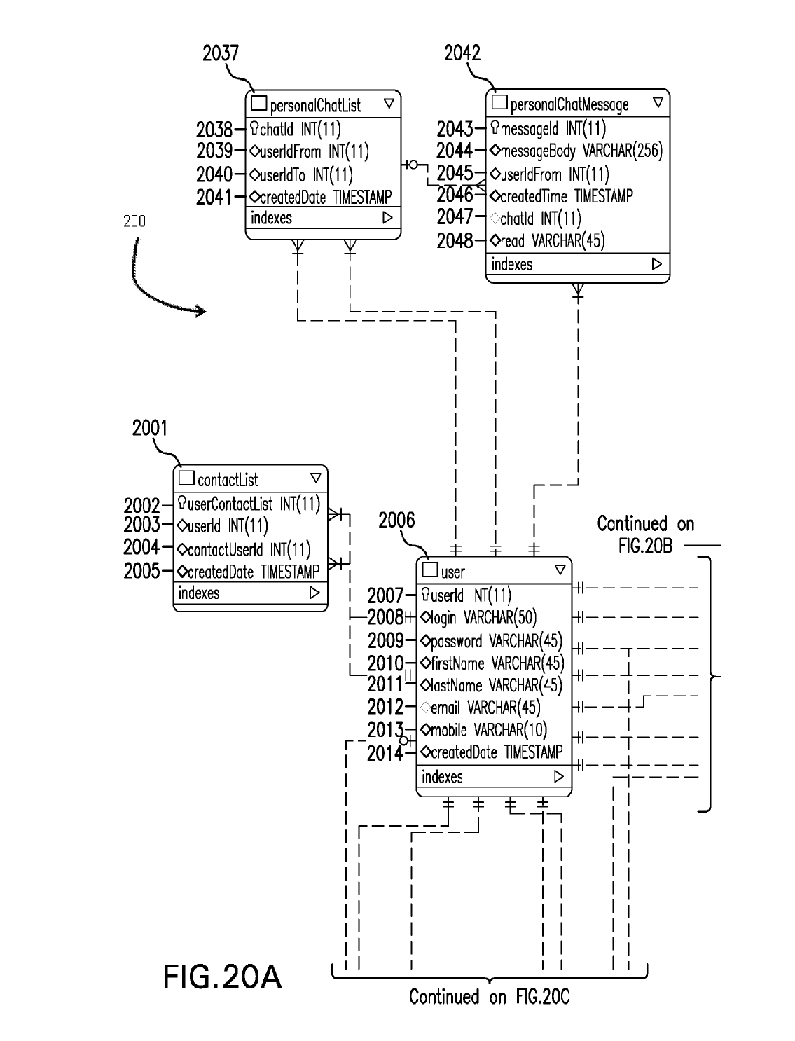

Referring to FIG. 18, a process block diagram for a method for group communication in an enterprise is shown. Processing begins at start block 1801 and proceeds to process block 1803. At process block 1803, registration information for a first mobile computing device connected to an external electronic communications network is accepted as associated with a first user who is a member of a division of the enterprise. Processing continues at process block 1805. At process block 1805, the registration information is stored by a server computing device connected to an internal electronic communications network behind a firewall in a database in a first record associated with the first user. Processing continues at process block 1807. At process block 1807, a command is accepted from a first client program executing on the first mobile computing device to create a subgroup within a group corresponding to the division of the enterprise of the first user and a second user who is a member of the division of the enterprise. Processing continues at process block 1809. At process block 1809, the record associated with the first user is modified to indicate the first user's membership in the subgroup. Processing continues at process block 1811. At process block 1811, an invitation to join the subgroup is pushed to a second mobile computing device of the second user. Processing continues at process block 1813. At process block 1813, a confirmation that indicates that the second user consents to join the subgroup is accepted from a second client program on the second mobile computing device. Processing continues at process block 1815. At process block 1815, a second record in the database is modified to indicate the second user's membership in the subgroup. Processing continues at process block 1817. At process block 1817, a message is pushed to the first and second mobile computing devices based on the membership of the first and second user's membership in the first group. The message pushed may be a simple push of an email or text message, or may include tasks, calendar events, or to-do list items. The message push may also include sub-steps of creating, in the database, an aggregated calendar record (or task list or to-do list) associated with the first user that incorporates all calendar events (or task list items or to-do list items) associated with the subgroup and all calendar events (or task list items or to-do list items) associated with a second subgroup within the group in which the first user is also a member, but in which the second user is not a member; and sending that aggregated calendar record (or task list or to-do list) to the first mobile computing device. Processing terminates at finish block 1819.

Referring to FIG. 18A. Intermediate steps of the method for group communication in an enterprise are shown in a segment of the process block diagram of FIG. 18. Processing continues from process block 1809 to process block 1821. At process block 1821, upon modifying the record associated with the first user to indicate the first user's membership in the subgroup, access to one or more resources associated with the subgroup and selected from the group consisting of a group shared file storage space, a group calendar, a group to-do list, a group task assignment, a group task progress tracker, and a group synchronized voice meeting system, is granted to the first user. Processing resumes at process block 1811. Processing continues from process block 1815 to process block 1823. At process block 1823, upon modifying the record associated with the second user to indicate the second user's membership in the subgroup, access to the one or more resources associated with the subgroup to which the first user also has access is granted to the second user. Processing resumes at process block 1817.

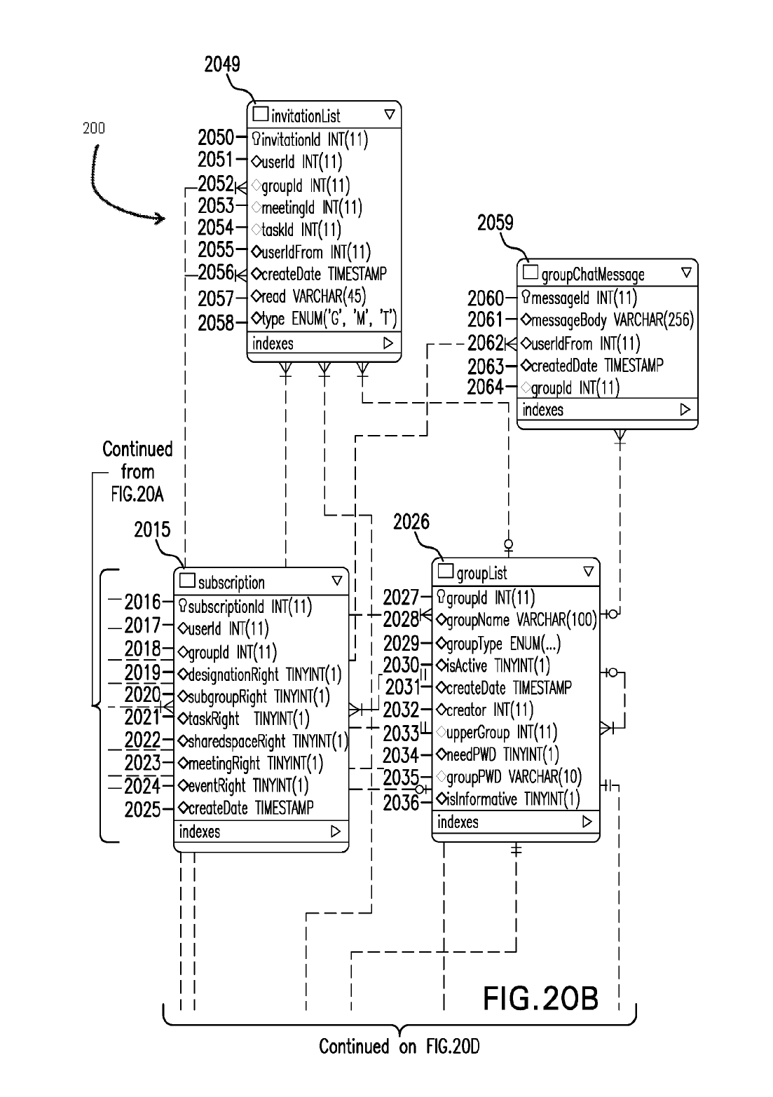

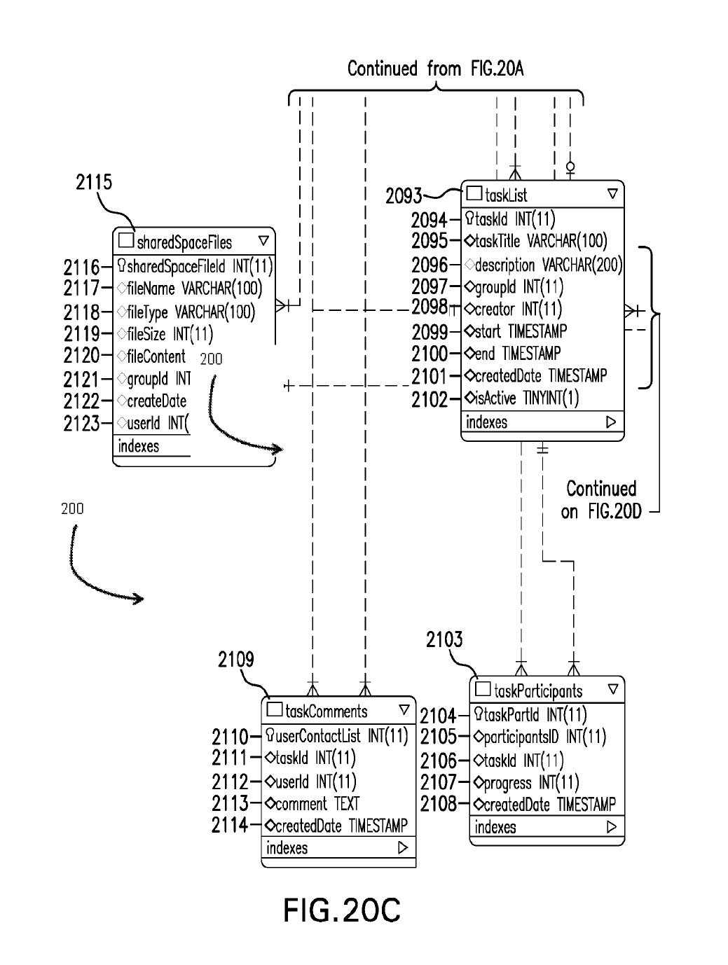

The enterprise mobile data system also supports geolocation based grouping, where group members are added to and removed from a location-specific group dynamically depending on users' geolocation. Referring to FIG. 19 another process block diagram for a method for group communication in an enterprise is shown. Processing begins at start block 1901 and proceeds to process block 1903. At process block 1903, a record for each of a plurality of users in the enterprise is recorded in a database by a server computing device connected to an internal electronic communications network behind a firewall. Processing continues at process block 1905. At process block 1905, a group associated with a physical location is created in the database. Processing continues at process block 1907. At process block 1907, registration information for a mobile computing device connected to an external electronic communications network outside the firewall that associates the mobile computing device with a first user among the plurality of users is recorded in the database. Processing continues at process block 1909. At process block 1909, a first message from a client program operated by the mobile computing device that indicates that the mobile computing device has entered into the physical location is accepted. Processing continues at process block 1911. At process block 1911, in response to receiving the first message, the record for the first user is modified to indicate the first user's membership in the group associated with the physical location. Processing continues at process block 1913. At process block 1913, message associated with the physical location is sent to all members of the group associated with the physical location. Processing continues at process block 1915. At process block 1915, a second message from the client program operated by the mobile computing device that indicates that the mobile computing device has exited the physical location is accepted. Processing continues at process block 1917. At process block 1917, in response to receiving the second message, the record for the first user is modified to indicate the first user's removal from the group associated with the physical location. Processing terminates at finish block 1919.

Referring to FIG. 19A, intermediate steps of the method for group communication in an enterprise are shown in a segment of the process block diagram of FIG. 19. Processing continues from process block 1911 to process block 1921. At process block 1921, upon modifying the record associated with the first user to indicate the first user's membership in the group associated with the physical location, access to one or more resources associated with the subgroup and selected from the group consisting of a group shared file storage space, a group calendar, a group to-do list, a group task assignment, a group task progress tracker, and a group synchronized voice meeting system, is granted to the first user. Processing resumes at process block 1913. Processing continues from process block 1917 to process block 1923. At process block 1923, upon modifying the record associated with the first user to indicate the first user's removal from the group associated with the physical location, the first user's access to the one or more resources associated with the group associated with the physical location is terminated. Processing proceeds to terminate at finish block 1919

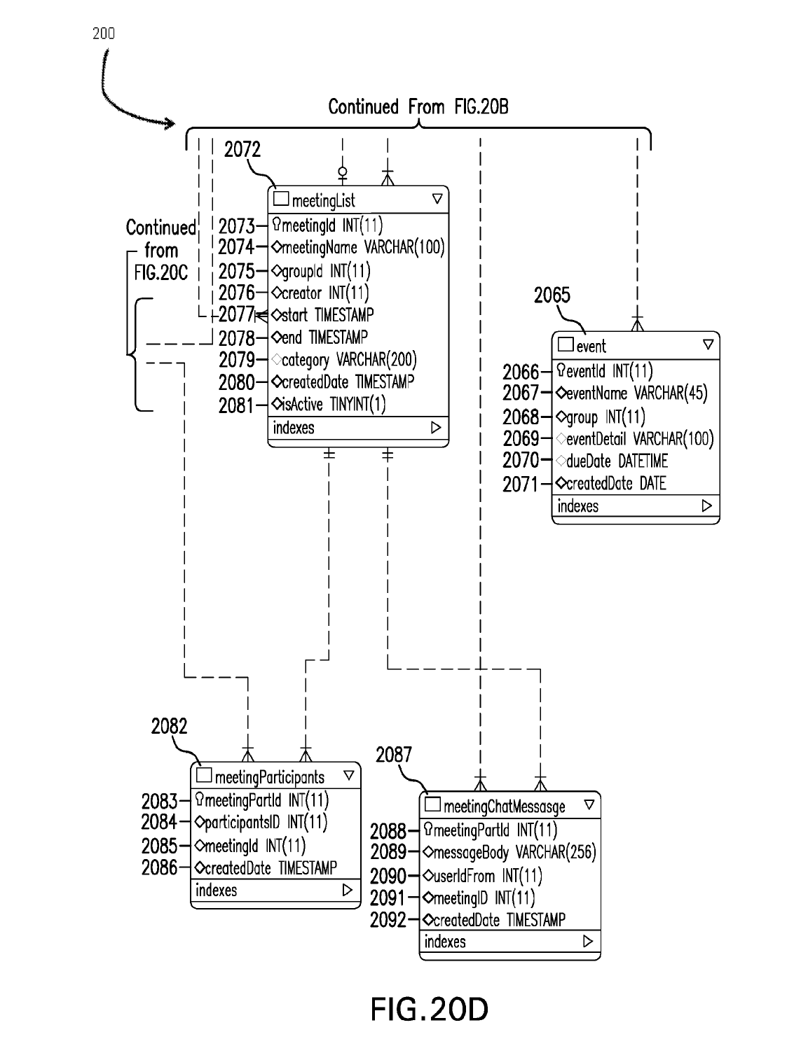

Table 19 includes information describing the exemplary database schema 2000 shown in FIG. 20. In table 20, the names and columns of the tables of the exemplary database schema 2000 are listed. An asterisk next to the name of a column denotes that it is the key of its respective table.

TABLE 19

| | | |
|---|---|---|
| Table | ContactList | 2001 |
| Column | * userContactListId INT(11) | 2002 |
| Column | userId INT(11) | 2003 |
| Column | contactUserId IN(11) | 2004 |
| Column | createdDate TIMESTAMP | 2005 |
| Table | user | 2006 |
| Column | * userId INT(11) | 2007 |
| Column | loginId VARCHAR(50) | 2008 |
| Column | password VARCHAR(45) | 2009 |
| Column | firstName VARCHAR(45) | 2010 |
| Column | lastName VARCHAR(45) | 2011 |
| Column | email VARCHAR(45) | 2012 |
| Column | mobile VARCHAR(45) | 2013 |
| Column | createdDate TIMESTAMP | 2014 |
| Table | subscription | 2015 |
| Column | * subscription Id INT(11) | 2016 |
| Column | userId(11) | 2017 |
| Column | groupId(11) | 2018 |
| Column | designationRight TINYINT(1) | 2019 |
| Column | subgroupRight TINYINT(1) | 2020 |
| Column | taskRight TINYINT(1) | 2021 |
| Column | sharedspaceRight TINYINTY(1) | 2022 |
| Column | meetingRight TINYINTY(1) | 2023 |
| Column | eventRight TINYINTY(1) | 2024 |
| Column | createDate TIMESTAMP | 2025 |
| Table | grouplist | 2026 |
| Column | * groupId(11) | 2027 |
| Column | groupName VARCHAR(100) | 2028 |
| Column | groupType ENUM(. . .) | 2029 |
| Column | isActive TINYINT(1) | 2030 |
| Column | createdDate TIMESTAMP | 2031 |
| Column | creator INT(11) | 2032 |
| Column | upperGroup INT(11) | 2033 |
| Column | needPWD TINYINT(1) | 2034 |
| Column | groupPWD VARCHAR(10) | 2035 |
| Column | inInformative TINYINT(1) | 2036 |
| Table | personalChatList | 2037 |
| Column | * chatID INT(11) | 2038 |
| Column | userIdFrom INT(11) | 2039 |
| Column | UserIdTo INT(11) | 2040 |
| Column | createdDate TIMESTAMP | 2041 |
| Table | personalChatMessage | 2042 |
| Column | * messageID INT(11) | 2043 |
| Column | messageBody VARCAR(256) | 2044 |
| Column | userIDFrom INT(11) | 2045 |
| Column | createdTime TIMESTAMP | 2046 |
| Column | chatId INT(11) | 2047 |
| Column | read VARCHAR(45) | 2048 |
| Table | invitationList | 2049 |
| Column | * invitationId INT(11) | 2050 |
| Column | userId INT(11) | 2051 |
| Column | groupId INT(11) | 2052 |
| Column | meetingId INT(11) | 2053 |
| Column | taskId INT(11) | 2054 |
| Column | userIdFrom INT(11) | 2055 |
| Column | createDate TIMESTAMP | 2056 |
| Column | read VARCHAR(45) | 2057 |
| Column | type ENUM(‘G’, ‘M’, ‘T’) | 2058 |
| Table | groupChatMessage | 2059 |
| Column | * messageId INT(11) | 2060 |
| Column | messageBody VARCHAR(256) | 2061 |
| Column | userIdFrom INT(11) | 2062 |
| Column | createdTime TIMESTAMP | 2063 |
| Column | groupId INT(11) | 2064 |
| Table | event | 2065 |
| Column | * eventID INT(11) | 2066 |
| Column | eventName VARCHAR(45) | 2067 |
| Column | groupId INT(11) | 2068 |
| Column | eventDetail VARCHAR(45) | 2069 |
| Column | dueDate DATETIME | 2070 |
| Column | createdDate DATE | 2071 |
| Table | meetingList | 2072 |
| Column | * meetingId INT(11) | 2073 |
| Column | meetingName VARCHAR(100) | 2074 |
| Column | groupID INT(11) | 2075 |
| Column | creator INT(11) | 2076 |
| Column | start TIMESTAMP | 2077 |
| Column | end TIMESTAMP | 2078 |
| Column | category VARCHAR(200) | 2079 |
| Column | createdDate TIMESTAMP | 2080 |
| Column | isActive TINYINT(11) | 2081 |
| Table | meetingParticipants | 2082 |
| Column | * meetingPartID INT(11) | 2083 |
| Column | participantsId INT(11) | 2084 |
| Column | meetingId INT(11) | 2085 |
| Column | createdDate TIMESTAMP | 2086 |
| Table | meetingChatMessage | 2087 |
| Column | * messageID INT(11) | 2088 |
| Column | messageBody VARCHAR(256) | 2089 |
| Column | userIdForm INT(11) | 2090 |
| Column | meetingId INT(11) | 2091 |
| Column | createdDate TIMESTAMP | 2092 |
| Table | taskList | 2093 |
| Column | * taskId INT(11) | 2094 |
| Column | taskTitle VARCHAR(100) | 2095 |
| Column | description VARCHAR(200) | 2096 |
| Column | groupId INT(11) | 2097 |
| Column | creator INT(11) | 2098 |
| Column | start TIMESTAMP | 2099 |
| Column | end TIMESTAMP | 2100 |
| Column | createdDate TIMESTAMP | 2101 |
| Column | isActive TINYINT(1) | 2102 |
| Table | taskParticipants | 2103 |
| Column | * taskPartId INT(11) | 2104 |
| Column | participatsID INT(11) | 2105 |
| Column | taskId INT(11) | 2106 |
| Column | progress INT(3) | 2107 |
| Column | createdDate TIMESTAMP | 2108 |
| Table | taskComments | 2109 |
| Column | * taskCommentsID INT(11) | 2110 |
| Column | taskId INT(11) | 2111 |
| Column | userId INT(11) | 2112 |
| Column | comment TEXT | 2113 |
| Column | createdDate TIMESTAMP | 2114 |
| Table | sharedspaceFile | 2115 |
| Column | * sharedspaceFileId INT(11) | 2116 |
| Column | fileName VARCHAR(100) | 2117 |
| Column | fileType VARCHAR(100) | 2118 |
| Column | fileSize INT(11) | 2119 |
| Column | fileContent MEDIUMBLOB | 2120 |
| Column | groupId INT(11) | 2121 |
| Column | createDate TIMESTAMP | 2122 |
| Column | userId INT(11) | 2123 |

Mobile computing devices, especially smart-phone type mobile computing devices often come equipped with geolocation identification functionality. The functionality may be based on receiving and processing global positioning system (GPS) signals and translating them into GPS coordinates, or, with less precision, based on access to one or more cellular telephone towers. A mobile computing device operating a mobile data messaging system client program can access this geolocation identification functionality and obtain the geolocation of the mobile computing device. Alternatively, the reception by the mobile computing device of a wireless communication network signal of unique to a particular geolocation also indicates the presence of the mobile computing device at that geolocation. Coordinates describing specific locations can be established as a geofence, which when entered or exited by a registered mobile computing device, initiates a join or drop of a group for the user of that mobile computing device.

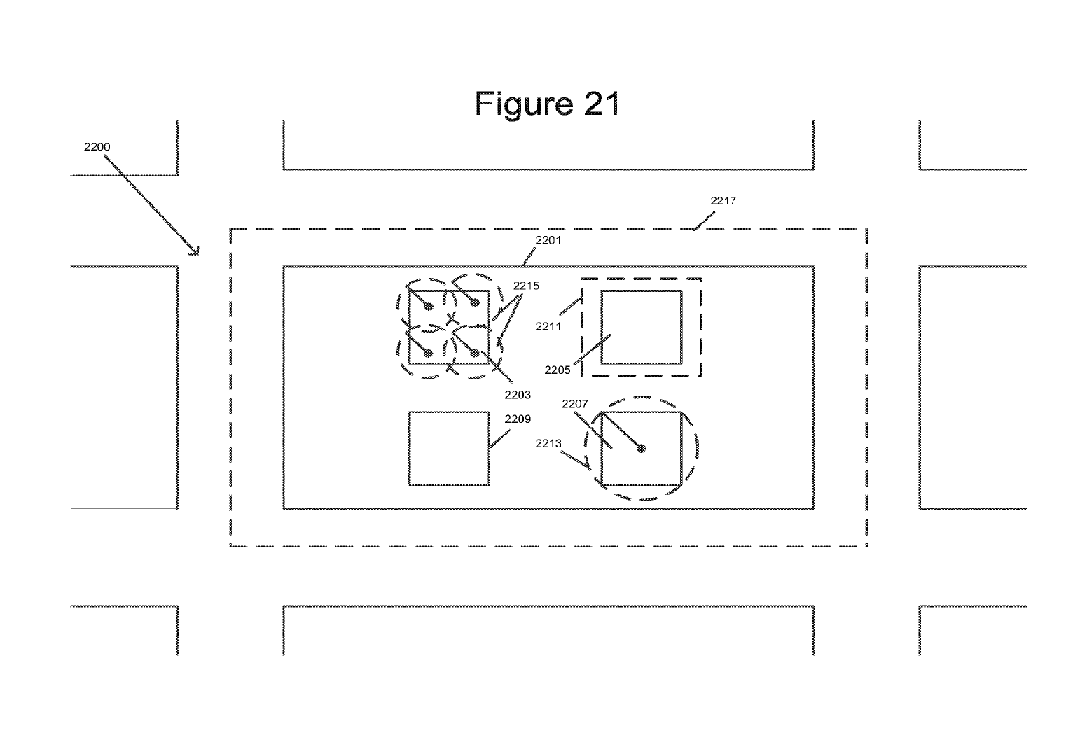

Referring to FIG. 21, an exemplary campus map 2200 for the enterprise with various geofencing features is shown. The campus 2201 contains several buildings, such as lecture hall 2203, library 2205, student center 2207, and dormitory 2209. A set of enterprise campus-specific geofences are established. GPS coordinates describing the corners of a block surrounding library 2205 are used to establish library geofence 2211. A radius around a single GPS point within student center 2207 is used to establish student center geofence 2213. GPS coordinates describing the comers of a block surrounding the campus 2201 are used to establish campus geofence 2217. Dormitory 2209 and lecture hall 2203 do not have GPS coordinate geofences. Various wireless networks 2215 from wireless access points within the lecture hall 2203 may be interpreted to indicate the presence of the mobile computing device within lecture hall 2203. The relationships of these buildings and their geofences are exemplary, and described so as to indicate various implementations, of geofences. These geofence coordinates are recorded, preferably as an array associating the coordinates with a named location, for example library geofence 2211 with library 2205. Alternatively, special sensors can be installed around the location in order to detect if any users coming to or leaving the zone by detecting and communicating with nearby registered mobile phone with mobile data messaging system client application with Wi-Fi, Bluetooth, or 3G/4G/LTE networks.

In a first GPS implementation of the dynamic group joining based on geolocation, the array of geofence coordinates are stored on the user's mobile computing device. The mobile data messaging system client program operating on the mobile device regularly compares the mobile computing device's GPS coordinates to the array of geofence coordinates. If the mobile data messaging system client program determines that the mobile computing device has entered a geofenced area by determining that the current coordinates of the mobile device are within the geofence coordinates of a location in the array, the mobile device sends a request to the mobile data messaging system server to join the user to a location based group when the mobile device is within the geofence coordinates. Similarly, if the mobile data messaging system client program determines that the mobile computing device has left a geofenced area by determining that the current coordinates of the mobile device are no longer within the geofence of a location, the mobile device sends a request to drop the user from the location based group.

In a second GPS implementation, the array of geofence coordinates are stored on the mobile data messaging system server. The mobile data messaging system client program operating on the mobile computing device regularly sends the device's GPS coordinates to the mobile data messaging system server. The mobile data messaging system server compares the received coordinates with the geofence coordinates in the array. The mobile data messaging system server assigns a user to a location based group if the user's mobile computing device has entered the geofence coordinates for that group's associated location. The mobile data messaging system server drops the user a location based group when the user's mobile computing device has left the geofence coordinates.

For example, when a user carries his registered mobile computing device into library 2205, he carries it into the coordinates describing library geofence 2211. He would then be added to the “library” geolocation messaging group, and granted access to library shared resources while in that group. If a hypothetical accident occurred in the library, then all members in the library geolocation messaging group could be notified on their mobile data messaging system client program by a message sent to the library geolocation messaging group. If a member of library geolocation messaging group exits the library, she has also exited the coordinates of library geofence 2211, and will be automatically removed from the library geolocation messaging group.

In another example, when a user carries his registered mobile computing device into student center 2207 she carries it into the coordinates describing student center geofence 2213. The user would then be added to the “student center” geolocation messaging group, and granted access to student center shared resources while in that group. A shared space file for this user group may include a menu for the student cafeteria, or calendar events of social gatherings presently occurring or occurring in the near future in the student center.

Temporal features of a geofence are also included. In a further example, when a user carries his registered mobile computing device into a conference room or classroom bounded by a geofence at a time when a meeting or class is scheduled, he may be provided access in a location and time specific group to class notes or a slide deck.

Any user of the enterprise mobile data system can also create a geolocation messaging group based on that users current location. Upon creation, the geofence array can be updated and pushed to messaging system client programs, or the group info can be pushed to messaging system client program can be sent to all users within the new geofence location. Then users who receive the message can choose whether to join the group.

A user who is in a geo-proximity group can also choose to leave the group.

Table 20 describes the attributes and methods of an example class used for maintaining the mobile computing device's GPS information and comparison with listed geofences.

TABLE 20
Class Name: SystemUserLocation
Brief Description: Collect mobile device GPS information and compare
with listed geofences

| | | Design |
|---|---|---|
| Attributes | Purpose | Characteristics |
| geofenceList | Hold all geofence | Private NSArray |
| | coordinates with descriptive | |
| | names (e.g. library) | |
| userGPS | Hold user's current GPS | Private NSString |
| | Coordinates | |
| userLocation | Hold user's current | Private NSString |
| | Geofence Location | |
| Methods | Purpose | Algorithmic Design |
| (void) | regularly (at a reasonable | Refresh user's GPS |
| getCurrentLocation: | walking time interval, say, | location |
| userGPS | every 5 minutes) update | |
| | the current location of the | |
| | phone. | |
| (BOOL) | upon update to userGPS, | Get the name of the |
| isInGeofence: | compare userGPS to | physical location |
| (userGPS, | coordinates of geofence | |
| geofenceList) | list and, if userGPS is | |
| userLocation | within one of those | |
| | locations, return the name | |
| | of that location | |
| (void)joinGroup: | send location name | Send name of user's |
| (userLocation) | information to database | location to system |
| | | database so database |
| | | can add user to the |
| | | group for that |
| | | location |

The embodiments shown and described in the specification are only specific embodiments of inventors who are skilled in the art and are not limiting in any way. Therefore, various changes, modifications, or alterations to those embodiments may be made without departing from the spirit of the invention in the scope of the following claims. The references cited are expressly incorporated by reference herein in their entirety.

What is claimed is:

1. A method for group communication in an enterprise, the method comprising
accepting registration information for a first mobile computing device connected to an external electronic communications network where the registration information is associated with a first user who is a member of a division of the enterprise;
storing, in a database and by a server computing device connected to an internal electronic communications network behind a firewall, the registration information in a first record associated with the first user;
accepting a command from a first client program executing on the first mobile computing device to create a subgroup within a group corresponding to the division of the enterprise where the subgroup comprises the first user;
modifying the first record associated with the first user to indicate the first user's membership in the subgroup;
pushing, to a second mobile computing device of a second user, an invitation to join the subgroup where the second user is a member of the division of the enterprise;
accepting, from a second client program on the second mobile computing device, a confirmation that indicates that the second user consents to join the subgroup;
modifying a second record in the database to indicate the second user's membership in the subgroup; and
pushing a message to the first and second mobile computing devices based on the membership of the first and second users' memberships in the subgroup.

2. The method of claim 1, further comprising
upon modifying the first record associated with the first user to indicate the first user's membership in the subgroup, granting, to the first user, access to one or more resources associated with the subgroup and selected from the group consisting of a group shared file storage space, a group calendar, a group to-do list, a group task assignment, a group task progress tracker, and a group synchronized voice meeting system; and
upon modifying the record associated with the second user to indicate the second user's membership in the subgroup, granting, to the second user, access to the one or more resources associated with the subgroup to which the first user also has access.

3. The method of claim 1, further comprising
creating, in the database, an aggregated calendar record associated with the first user that incorporates all calendar events associated with the subgroup and all calendar events associated with a second subgroup within the group in which the first user is also a member, but in which the second user is not a member; and
sending the aggregated calendar record to the first mobile computing device.

4. The method of claim 1 further comprising sending, to the first mobile computing device, a calendar event associated with the subgroup and a calendar event associated with a second subgroup within the group in which the first user is also a member, but in which the second user is not a member.

5. The method of claim 1 further comprising
creating, in the database, an aggregated to-do record associated with the first user that incorporates all to-do items associated with the subgroup and all to-do items associated with a second subgroup within the group in which the first user is also a member, but in which the second user is not a member; and
sending the aggregated to-do record to the first mobile computing device.

6. A method for group communication in an enterprise, the method comprising
recording, in a database and by a server computing device connected to an internal electronic communications network behind a firewall, a record for each of a plurality of users in the enterprise;
creating, in the database, a group associated with a physical location;
recording, in the database, registration information for a mobile computing device connected to an external electronic communications network outside the firewall where the registration information associates the mobile computing device with a first user among the plurality of users;
accepting a first message from a client program operated by the mobile computing device that indicates that the mobile computing device has entered into the physical location;
modifying, in response to receiving the first message, a record for the first user to indicate the first user's membership in the group associated with the physical location;
sending a message associated with the physical location to all members of the group associated with the physical location;
accepting a second message from the client program operated by the mobile computing device that indicates that the mobile computing device has exited the physical location; and
modifying, in response to receiving the second message, the record for the first user to indicate the first user's removal from the group associated with the physical location.

7. The method of claim 6 further comprising
upon modifying the record for the first user to indicate the first user's membership in the group associated with the physical location, granting, to the first user, access to one or more resources associated with the group and selected from the group consisting of a group shared file storage space, a group calendar, a group to-do list, a group task assignment, a group task progress tracker, and a group synchronized voice meeting system; and
upon modifying the record for the first user to indicate the first user's removal from the group associated with the physical location, terminating the access of the first user to the one or more resources associated with the group associated with the physical location.

8. The method of claim 6 where the registration information is a mobile telephone number.

9. A non-transitory computer readable medium storing instructions that, when executed by a processor, effectuate operations for group communication in an enterprise, the operations comprising
recording, in a database and by a server computing device connected to an internal electronic communications network behind a firewall, a record for each of a plurality of users in the enterprise;
creating, in the database, a group associated with a physical location;
recording, in the database, registration information for a mobile computing device connected to an external electronic communications network outside the firewall, where the registration information associates the mobile computing device with a first user among the plurality of users;
accepting a first message from a client program operated by the mobile computing device that indicates that the mobile computing device has entered into the physical location;
modifying, in response to receiving the first message, a record for the first user to indicate the first user's membership in the group associated with the physical location;
sending a message associated with the physical location to all members of the group associated with the physical location;
accepting a second message from the client program operated by the mobile computing device that indicates that the mobile computing device has exited the physical location; and
modifying, in response to receiving the second message, the record for the first user to indicate the first user's removal from the group associated with the physical location.

10. A method for group interaction between members of an enterprise and based on membership within divisions of the enterprise, the method comprising
storing in a database a set of division membership information that identifies at least a first member and a second member as members of at least a first enterprise division, wherein the storing in the database is performed by a server computing device connected to an internal electronic communications network, wherein the server computing device and the internal electronic communications network are located within bounds of a firewall, wherein a first computing device is at least temporarily associated with the first member and a second computing device is at least temporarily associated with the second member, wherein the first computing device and the second computing device are each located within the bounds of the firewall;
providing access for the first member and the second member to a set of first enterprise division specific content, wherein the set of first enterprise division specific content is stored within the bounds of the firewall;
permitting collaboration of the set of first enterprise division specific content between the first member and the second member;
receiving a set of registration information associated with a third computing device and a third member, wherein the set of division membership information also identifies the third member as a member of at least the first enterprise division, wherein the third computing device is capable of accessing the internal electronic communications network through a connection to an external electronic communications network;
storing the set of registration information in the database;
providing access for the third member to the set of first enterprise division specific content;
permitting collaboration of the set of first enterprise division specific content between the first member, the second member, and the third member;
receiving a command from a first client program executing on the first computing device to create a subdivision within the first enterprise division, wherein the command identifies at least the first member and the third member as members of at least a first enterprise subdivision;
modifying the set of division membership information to include the first enterprise subdivision and to identify the first member and the third member as potential members of the first enterprise subdivision;
pushing an invitation to join the first enterprise subdivision to the third computing device;
accepting a confirmation that indicates that the third member consents to join the first enterprise subdivision, wherein the confirmation is received from a client program executing on the third computing device;
pushing a message to the first computing device and the third computing device based on the membership of the first member and the third member in the first enterprise subdivision;
providing access for the first member and the third member to a set of first enterprise subdivision specific content, wherein the set of first enterprise subdivision specific content is stored within the bounds of the firewall; and
permitting collaboration of the set of first enterprise subdivision specific content between the first member and the third member.

11. A system for facilitating group interaction between members of an enterprise based on membership within divisions of the enterprise, the system comprising
an internal electronic communications network;
a server computing device in communication with the internal electronic communications network, wherein the server computing device and the internal electronic communications network are located within the bounds of a firewall; and
a database in communication with the server computing device, wherein storing in the database is performed by the server computing device,
wherein a first computing device is at least temporarily associated with a first member,
wherein a second computing device is at least temporarily associated with a second member,
wherein the first computing device and the second computing device are each located within the bounds of the firewall,
wherein a third computing device is at least temporarily associated with a third member,
wherein the third computing device is configured to access the internal electronic communications network through a connection to an external electronic communications network,
wherein a set of division membership information identifies at least the first member, the second member, and the third member as members of at least a first enterprise division,
wherein the system is configured to provide access for the first member and the second member to a set of first enterprise division specific content,
wherein the set of first enterprise division specific content is stored within the bounds of the firewall,
wherein the system is further configured to permit collaboration of the set of first enterprise division specific content between the first member and the second member,
wherein the system is further configured to receive a set of registration information associated with the third computing device and the third member,
wherein the system is further configured to store the set of registration information in the database,
wherein the system is further configured to provide access for the third member to the set of first enterprise division specific content,
wherein the system is further configured to permit collaboration of the set of first enterprise division specific content between the first member, the second member, and the third member,
wherein the system is further configured to receive a command from a first client program executing on the first computing device to create a subdivision within the first enterprise division,
wherein the command identifies at least the first member and the third member as members of at least a first enterprise subdivision,
wherein the system is further configured to modify the set of division membership information to include the first enterprise subdivision and to identify the first member and the third member as potential members of the first enterprise subdivision,
wherein the system is further configured to push an invitation to join the first enterprise subdivision to the third computing device,
wherein the system is further configured to accept a confirmation that indicates that the third member consents to join the first enterprise subdivision,
wherein the confirmation is received from a client program executing on the third computing device,
wherein the system is further configured to push a message to the first computing device and the third computing device based on the membership of the first member and the third member in the first enterprise subdivision,
wherein the system is further configured to provide access for the first member and the third member to a set of first enterprise subdivision specific content,
wherein the set of first enterprise subdivision specific content is stored within the bounds of the firewall, and
wherein the system is further configured to permit collaboration of the set of first enterprise subdivision specific content between the first member and the third member.
